(19) United States
(12) Patent Application Publication
(10) Pub. No.: US 2016/0344118 A1
(43) Pub. Date: Nov. 24, 2016

(54) Separable Electrical Connector and Method of Making It

(71) Applicants: Ching-Ho (NMI) Hsieh, Tao-Yuan City (TW); Ming-Hsing (NMI) Wu, Tao-Yuan (TW); Chung-Chi (NMI) Huang, Tao-Yuan (TW); Chih-Peng (NMI) Fan, Tao-Yuan (TW); David L. Chen, Los Altos, CA (US)

(72) Inventors: Ching-Ho (NMI) Hsieh, Tao-Yuan City (TW); Ming-Hsing (NMI) Wu, Tao-Yuan (TW); Chung-Chi (NMI) Huang, Tao-Yuan (TW); Chih-Peng (NMI) Fan, Tao-Yuan (TW); David L. Chen, Los Altos, CA (US)

(21) Appl. No.: 15/158,085

(22) Filed: May 18, 2016

Related U.S. Application Data
(60) Provisional application No. 62/163,539, filed on May 19, 2015.

(51) Int. Cl. H01R 12/52; H01R 43/24; H01R 43/02; H01R 43/16; H01R 12/79; H01R 13/24; H01R 12/71; H01R 43/00

(52) U.S. Cl. CPC H01R 12/52; H01R 12/716; H01R 43/24; H01R 43/007; H01R 43/16; H01R 12/79; H01R 13/2442; H01R 13/245; H01R 43/0235

(57) ABSTRACT

A novel, low profile connector element is disclosed for the purpose of electrically and mechanically interconnecting circuit elements in electronic devices, said circuit elements including but not limited to printed circuit boards, flexible printed circuits, rigid flex circuits, semiconductors, semiconductor package substrates, ground shields, and batteries, whereby the connector includes electrical contacts which have a unitary structure consisting of at least a distal end, a proximal end, and a middle section between the distal and proximal ends. The contacts of the present invention exhibit a contact diametric true position with respect to one another in an array of less than 0.2 millimeters. The electrical contacts are created in batch form from a high conductivity sheet of spring material such as a copper alloy. At least one end of the contact is elastic and emanates from one surface of the connector housing to enable formation of a separable, low resistance and reliable electrical connection to a terminal on a mating circuit element. A second end of the contact may also be elastic, or may be designed to permanently mount on a terminal on a second mating circuit element using attachment means such as solder. Contacts can be made by batch stamping and forming in reel to reel processing, and may remain integral to the contact strip or sheet during all connector fabrication processes including contact stamping, contact forming, contact plating, integration into the connector housing such as by over-molding, and through all other processing until singulation of the individual contacts and the whole of the connector′ from the contact sheet, and, as needed to provide proper connector function, from one another.

### CROSS REFERENCE TO RELATED PATENT

The present patent claims the benefit of a previously-filed provisional patent application entitled “Low Profile, Normal Force Electrical Connector” filed by Ching-Ho Hsieh et al. on May 19, 2015, as Ser. No. 62/163,539. The specification and drawings from this provisional patent application are specifically incorporated herein by reference.

### BACKGROUND

1. Field of the Invention

The present invention relates to separable electrical connectors used for the interconnection of circuit elements in electronic devices such as computers, mobile phones, tablets, laptop computers, medical electronics, opto-electronic assemblies, sensor electronics, or other devices requiring separable electrical interconnections for ease of testing, assembly, rework, repair, and/or for other reasons.

2. Background of the Invention

Complex electronic devices such as computers and mobile phones require electrical interconnection of various circuit elements, such as printed circuit boards, flexible printed circuit cables, rigid-flex circuits, ceramic substrates, semiconductor package substrates, opto-electronic devices, batteries, and other elements of electronic devices. Frequently, it is desired that these interconnections be separable in order to facilitate low cost and simplified assembly, test, rework, and repair, or to avoid high temperature interconnection methods such as soldering, brazing, or conductive adhesive curing when certain subcomponents or elements of the assembly are sensitive to elevated temperatures, or for other reasons or combinations of reasons.

For this reason, there is frequently a plurality of separable electrical connectors found in a single electronic device. As these electronic devices evolve to provide increased functionality in smaller form factors, such as for mobile consumer electronic products, the electrical connectors must simultaneously improve in function and performance while decreasing in size, including area of the connector's footprint (x by y area occupied on the mating circuit elements) and its profile (thickness). Low profile connectors also facilitate reduced electrical resistance across the connector, allowing them to carry more power with less temperature increase due to resistive losses, and often enable better signal integrity due to lower inductance and reduced impedance discontinuity.

It is frequently required that these electrical connectors meet stringent performance requirements, such as maintaining high signal integrity of the interconnected electronic signals at high operating frequencies, providing low electrical contact resistance to enable high current capacity with minimal temperature rise, surviving high levels of mechanical shock and vibration without transient or permanent interruptions in the electrical path, maintaining reliable interconnections through various environmental stresses during life of the product, and meeting other stringent performance requirements that are specific to various applications such as aerospace, medical electronics, and other demanding applications. As electronic devices continue to be miniaturized, the interconnection terminals or pads on the circuit elements being interconnected frequently are required to be reduced in size (area) and located on finer pitches (spaced closer together), requiring electrical connectors with improved means for precise and accurate alignment to the circuit elements and with very accurate true position of the contacts in the connector relative to each other and to the position of these alignment means. Manufacturing costs of these connectors must be low to keep pace with the competitive environment and endproduct pricing constraints, so connector materials and manufacturing processes must be simple, streamlined and/or low cost.

Many connectors used in present miniaturized electronic devices fall into one of two general categories: two piece ‘mezzanine’ connectors, and one piece ‘ZIF’ connectors, although other connectors including Neoconix PCBeam™ ‘normal force’ connectors are also frequently used. Both ZIF and mezzanine connectors frequently have difficulty surviving mechanical shock and vibration forces experienced during normal use of the device without transient or permanent interruptions in the electrical path, unless secondary retention elements are included which occupy additional space in the device. Since space in miniaturized devices is at a premium, this is not ideal. As these connectors continue to be miniaturized to fit into shrinking device form factors, the sensitivity to shock and vibration typically increases due to reduced area for application of retention forces. Frequently, the profile (thickness) of these connectors is well above 1 millimeter, which can be a limiting factor in shrinking the thickness of devices like high end mobile ‘smart-phones’. Commonly, ZIF and mezzanine connectors contribute to a reduction in signal fidelity at high frequencies due to relatively long, high inductance leads, and/or due to impedance discontinuities at the transitions from the mating circuit element terminals to the connector's electrical contacts. Frequently, the power handling capacity of these two connector types is less than or equal to 0.2 amps of current per individual contact due to high contact resistance and long current path, requiring an increase in the number of contacts and thus an increase in the connector's footprint size in order to function effectively as high power connectors, such as battery connectors, without unacceptable temperature rise during operation. In addition, contact true position of these connectors is frequently inadequate to enable the desired level of miniaturization in the system and of the circuit elements in the system. In many cases, these connectors are manufactured by stamping and forming electrical spring contacts into separate contact elements, before or during the insertion of those contacts sequentially or in ganged fashion into a pre-molded connector housing. In this situation, the true position tolerance of the contacts is defined cumulatively by any inaccuracies of the insertion process and inaccuracies in the precision of various dimensions of the molded connector housing structures that align and retain the electrical spring contacts, as well as inaccuracies in the dimensions or shape of the formed spring contacts and of the insertion process. In addition, the insertion process is frequently sequential and thus relatively time consuming and expensive, compared to batch processes. The retention of the contacts in the housing and their position in these mezzanine and ZIF connectors is typically maintained by frictional forces, rather than by true bonding of the contacts to the connector housing as would be the case if the housing were molded directly onto a portion of the contacts. It is desirable and would be an advance over the current state of the art to provide a connector structure and manufacturing process that offers high signal fidelity, high mechanical and electrical spring compliance and working range, high resistance to mechanical shock and vibration, fine contact pitch, low connector profile, high current capacity, very accurate and repeatable contact true position, low cost batch manufacturing processes, and reliability through environmental stresses during operating life in one connector type.

### SUMMARY OF INVENTION

One objective of the present invention is to provide a low profile electrical connector for interconnecting two circuit elements in an electronic system or device, such as two printed circuit boards, or a printed circuit board and a flexible printed circuit, or a semiconductor package substrate and a printed circuit board, or a rigid-flex circuit and a flexible or rigid printed circuit, and which provides many or all of the characteristics including high electrical performance (including low electrical resistance, high signal fidelity at high operating frequencies), high current carrying capacity, high mechanical and electrical compliance and working range of the electrical spring contacts, high tolerance of mechanical shock and vibration without suffering transient or permanent opens, fine contact pitch for small connector footprint, positive retention and ease of assembly, and low connector profile. Another objective of the present invention is to maintain very tight true position tolerances for the electrical contacts in such a connector, relative to each other and to alignment features on the connector body, so that it is capable of interconnecting miniaturized circuit elements with interconnection terminals of small size and/or on a tight pitch. It is a further objective of this invention to provide the above features in a connector which can be manufactured in relatively few process steps and at lower cost than commonly used connectors, including by mass stamping and forming of the electrical spring contacts and mass integration of these electrical contacts into an insulative connector housing, and by other batch processing methods including surface finishing and singulation. It is a further objective of the present invention to reduce the impedance discontinuity at the interconnection by enabling smaller terminal mating pads on the mating circuit element, thereby reducing capacitance both between the connector structure and the mating terminal pad, and between the mating terminal pad and other circuit structures within the mating circuit element.

One aspect of the present invention comprises a plurality of patterned and formed electrical spring contacts which are created from a sheet or strip of electrically conductive spring material, such as a copper alloy, and which are integrated into a connector body or connector housing en masse while still integrally connected to the sheet or strip. The terms sheet and strip may at times be used interchangeably in further discussion of the present invention, and refer to a planar sheet of conductive spring material, typically with a thickness between 10 microns and 200 microns, but preferably between 25 and 50 microns. In general, a strip would be longer and narrower than a sheet, whereby a sheet width might be 50% or more of its length, and a strip more typically would have a width equal to less than 25% of its length. Strip can also refer to a very long length of contact sheet material which can be kept in and processed in coils, in reel to reel format, during manufacture of the connector. The terms connector body and connector housing may also be used interchangeably in further description of the present invention, and generally refer to an insulative structure that retains the spring contacts and maintains the integrity of the connector, including assisting with its alignment to other circuit elements. At times the connector body or housing may be referred to as a molded connector body or housing, but this should not be construed to limit the description of the process for creating the body or housing to molding or injection molding processes. Other means of creating the housing and integrating it with the contact strip may include deposition, 3D printing, lamination, adhesive bonding, or other fabrication means.

The integration of the plurality of electrical spring contacts into a connector housing may be accomplished with a molding process, such as injection molding or over-molding or film assisted over-molding, or by other molding processes, or by other means such as three dimensional printing, deposition, electrophoretic deposition, lamination, or by other common processes or combinations of these processes that can encapsulate or surround structures with an insulative material. In the present invention, the connector body is formed over an array of formed electrical contacts subsequent to the patterning and three dimensional forming of the plurality of electrical contacts, but while the electrical contacts are still integrated with and connected to the contact sheet as a unitary element.

The contacts in one embodiment of this invention have been formed into a three dimensional shape while one or more regions of each contact are still integrated into the contact sheet or strip, prior to molding or other means of applying the insulative connector body. The three dimensional contact of one embodiment includes a distal end comprising an elongated, flexible cantilever beam-like spring to enable separable electrical interconnection to electrically conductive terminals on a circuit element such as a printed circuit board, a flexible circuit, a rigid-flex circuit, or a semiconductor package substrate, through application of normal force between the mating circuit element and the connector. The distal end of the contact is designed so as to provide significant mechanical working range within the elastic limits of the spring sheet material, and likewise significant total electrical compliance whereby the contact spring provides low electrical resistance across a large range of compression distance. In one embodiment of the present invention, the distal end of the contact may take the shape of the PCBeam™ electrical contact technology previously disclosed by Neoconix, Inc. In another embodiment, the distal end of the contact resembles a cantilever beam.

In one embodiment of the present invention, the distal end of the electrical contact is preferably designed to provide wipe of the tip of the distal end across the mating terminal pad on the mating circuit element during compression. This wiping action assists in reducing contact resistance by breaking through any oxide layers or contaminants on the contact tip and/or the mating terminal pad. In a preferred embodiment, the distance of this wiping is 25 to 100 microns. The distal end of the contacts emanates from the original plane of the contact sheet and protrudes above a first surface of the contact sheet and above a first surface of the insulative connector body, at an angle of less than 90 degrees. In one embodiment, the distal end of the contact emanates from the plane of the contact sheet at an angle which gradually increases along a portion of the length of the distal end from where it is coplanar with the contact sheet toward the tip of the distal end. The three dimensional contact also comprises a proximal end. In one embodiment for a surface mount connector, the proximal end is a semi-rigid terminal or ‘solder tail’, approximately parallel to the plane of a second, opposing surface of the insulative connector body and parallel to the original plane of the contact sheet. The proximal end in this embodiment is used for permanently or semi-permanently joining the contacts of the connector to terminals on a second electronic circuit element using solder, conductive adhesive, or other means to provide an electrical and mechanical attachment and interconnection. The second electronic circuit element can be a printed circuit board, a flexible printed circuit, a rigid-flex circuit, a semiconductor package substrate, a semiconductor, a passive device, a battery, or other electronic circuit element. The electrical contact also comprises a middle section, which remains in the original plane of the contact strip or sheet after contact forming and which is integral with both the distal end and the proximal end of the electrical contact, such that the distal end, the middle section, and the proximal ends of the contact element form a unitary body. The middle section of the contact is substantially encapsulated on both surfaces by the connector body.

The formed, distal end of the contact emanates from the plane of the contact sheet at an angle of less than ninety degrees. The proximal end or solder tail emanates from the plane of the contact strip or sheet at an angle of approximately zero degrees, and hence is parallel but typically slightly elevated from the plane of the contact sheet or strip. In a preferred embodiment of this invention, the distal end of the contact emanates outward from a first surface of the contact sheet, and the proximal end of the contact is parallel to the contact sheet but protrudes above the second, opposing surface of the contact sheet.

In a preferred embodiment of the present invention, the design of the contact resembles a constant stress cantilever beam, with the width of the beam decreasing from its base, which emanates from the middle section of the contact, to its tip, where the mechanical and electrical connection is made to a mating circuit element. In a preferred embodiment, the width of the tip of the beam is less than 200 microns, and preferably is less than 150 microns.

The connector body is molded, deposited, laminated, or otherwise caused to encapsulate the plurality of electrical spring contacts of a quantity sufficient for the function of the specific interconnection requirement, this encapsulation occurring while the contacts are still integrated into the contact sheet or strip. This aspect of the present invention maintains the electrical contacts in precise alignment to one another, and enables very accurate true position of the contacts relative to one another and to the molded or otherwise formed connector body, which itself has integral alignment features to assist in integration of the finished connector into an electronic assembly. After molding or otherwise applying the connector housing or body, the distal ends of the electrical spring contacts emanate above the plane of a first surface of the molded connector body at an angle of less than ninety degrees, and preferably less than 60 degrees, such that it protrudes above the surface of the connector body. In one embodiment, for a surface mount connector, the proximal end of the contact emanates from a second, opposing surface of the connector body, ultimately becoming approximately parallel to the second surface but slightly proud of the plane of that second surface of the connector body. In a preferred embodiment of the present invention, the tip of the distal end of the contact protrudes substantially further from the first surface of the connector body than the distal end protrudes from the second surface of the connector body. In another embodiment of the present invention, there is a section of the proximal end of the contact immediately adjacent to the middle section of the contact which emanates from the second surface of the contact sheet for a short distance at an angle of approximately ninety degrees before the proximal end of the contact becomes oriented approximately parallel to the original plane of the contact sheet. This short section of the proximal end of the contact oriented 90 degrees to the plane of the contact sheet rigidifies the proximal end of the contact under application of normal force, such that it does not substantially compress, thereby functioning as a solder interconnection terminal for the contact rather than as a separable spring contact element, such as for use in surface mount connectors.

The molded or otherwise formed connector housing extends above both surfaces of the original plane of the contact sheet and encapsulates at least a portion of the middle section of the contact. In a preferred embodiment of the present invention, the molded connector body is designed with openings that allow the distal end of the contact to be unimpeded while it is fully compressed to a degree such that its tip is approximately co-planar with the first surface of the connector body. In a preferred embodiment, the distal end of the spring contact is designed such that when it is fully compressed to a degree where its tip is co-planar with the first surface of the connector body, it remains within its elastic range so that it does not deform plastically, and also so that it provides sufficient contact force between the contact tip of the distal end and the mating terminal such that it provides a low electrical contact resistance interconnection. In another embodiment of the present invention, the contact sheet material within the distal end of the contact remains in the elastic range during full compression of the contact distal end to the first surface of the connector body, but a plated surface finish layer or layers may not remain in its elastic range, and may therefore plastically yield a small amount during the first full compression of the contact distal end. In this embodiment, there would typically be no additional yielding of the plated surface finish material on subsequent compression cycles of the contact distal end.

Because the distal end of the contact preferably remains within its elastic range during full compression, it can therefore attain the same height above the first surface of the connector body when released as before compression. In this way, the contact element can survive and function through multiple mating cycles without plastic deformation or excessive fatigue or work hardening. The proximal end of the contact is preferably designed with a shape such that it does not deform or compress significantly during compression of the distal end of the contact through application of normal force through a first mating circuit element above the first surface of the connector body. The electrical connector of this embodiment of the present invention provides an electrical interconnection between two circuit elements by forming a permanent or semipermanent electrical interconnection between the proximal ends of the contacts to conductive terminals on one mating circuit element, and separable electrical interconnections between the distal ends of the contacts and conductive terminals on a second, opposing mating circuit element, through application of normal force between the two mating circuit elements toward one another.

In a preferred embodiment of the present invention, the distal and proximal ends of a single contact are adjacent to each other when viewed from a perspective normal to the surface of the contact sheet, and they are conjoined at a middle section of the contact at the end of the contact away from the tips of the distal and proximal ends of the contact. In another embodiment for a surface mount connector, the distal end of the contact is longer than the proximal end.

For another embodiment of the present invention, for a non-surface mount connector where both mating circuit elements are separably mated to, the distal end of the contact and the proximal end of the contact are of approximately the same length, and have approximately the same two dimensional and three dimensional shape and thickness, such that both distal and proximal ends can function as spring elements analogous to cantilever beams, and such that normal force required to compress the proximal end and the distal end of the contact is the same. In this embodiment of the present invention, the connector is designed to mate separably to each of two opposing, mating circuit elements. In this embodiment, the patterned and formed electrical contacts also remain integral to the contact strip during patterning, forming, and application of the connector housing.

The electrical contacts in the present invention may maintain their connection to the contact strip or sheet in various locations. In one embodiment, the contacts remain integral to the contact strip through an attachment point at the middle section of the contact. In another embodiment of the present invention, the contacts are integral to the contact sheet after stamping and forming of the contacts but before singulation, through a connection at the tip of the proximal end of the contact. This connection may be severed after the connector housing is applied to the plurality of contacts in the array for the connector. In a preferred embodiment, all the connections of all of the contacts to the contact sheet are severed en masse, using a stamping die or other cutting method, after the connector housing has been applied. In another embodiment, these connections are severed sequentially in rows.

In another embodiment, a power connector has a plurality of contacts n, where n is less than the total number of contacts in the connector, that are ganged together through conjoining of their middle sections, such that after singulation these ganged contacts remain electrically shorted together, for making high power interconnections and for grounding or return terminals. In another embodiment, n elastic distal contact ends are attached to m proximal contact ends, where n is greater than m. In another embodiment of this invention, the ganged contacts with conjoined middle sections remain connected to the contact sheet after stamping and forming of the contacts and through application of the connector housing, through an extension of the middle section at the edges of the contact array that remained integral with and connected to the contact sheet. After the connector housing is applied, the connector is singulated by cutting or otherwise separating or severing this extension of the middle section of the contacts at the edge of the connector array from the contact sheet or strip. In a preferred embodiment, all of these connections in a given connector are severed en masse, such as by use of a stamping die.

In another embodiment of this invention, both the distal ends and the proximal ends of the contacts are elongated, flexible cantilever beam-like springs to enable separable electrical interconnection of both sides of the connector to electrically conductive terminals on two opposing circuit elements such as printed circuit boards, flexible printed circuits, rigid-flex circuits, semiconductor package substrate, passive components, semiconductors, or batteries, to separably interconnect one electrical circuit element to the other. In this embodiment, both the distal end and the proximal end of the contact are designed so as to provide significant mechanical working range within the elastic limits of the spring sheet material, and likewise significant total electrical compliance whereby the contact spring provides low electrical resistance across a broad range of compression distance. The distal contact ends and the proximal contact ends in this embodiment emanate from opposing surfaces of the contact sheet, and are connected to one another with a middle contact section such that the distal end, proximal end, and middle section of the contact are a unitary body, and remain integral with the contact sheet through application of the connector housing or body, and are then singulated from the contact strip and, as needed, from one another.

Because the contacts are defined, formed, and incorporated into the connector housing while still integrated into the sheet or strip of contact material, and the tooling that molds, deposits, laminates, or otherwise applies the housing material is accurately aligned to the contact sheet or strip through high precision tooling features in the strip and in the tooling, the contact true positions are maintained very accurately with respect to one another and with respect to the connector housing alignment features, which can be comprised of integral features of the housing including protrusions, slots, holes, pins, or other alignment features. In a preferred embodiment of the present invention, the connector housing is applied by an injection molding process using a precision mold tool, said tool having precise alignment features and jigs to locate the mold over the contact array on the contact sheet or strip. This molding process thereby can provide a very accurate true position for the contacts relative to the alignment features molded as part of the housing, and allows the resulting connector to be used for electrical interconnection of highly miniaturized circuit elements with small mating terminal pads on a tight pitch and spacing.

The two dimensional shape of the electrical contacts of the present invention is defined in the sheet or strip using a patterning process which can include stamping, etching, laser machining, a combination of these processes, or other processes or combinations of processes that can cut or remove metal selectively without separating the contacts completely from the sheet or strip.

In one embodiment of the invention, during the patterning to achieve the two dimensional shape of the electrical contacts while they are still integrated in the contact sheet or strip, frangible sections are created at the locations where the contacts will ultimately be separated (singulated) from one another or from the contact strip or sheet, to enhance the ease of singulation of the contacts from one another for electrical isolation as needed for the specific connector function requirements, and/or for separation of the connector as a whole from the contact sheet or strip. The design of the frangible section may be created such that, when necessary, the frangible area can be more easily fractured or broken to achieve the isolation and separation of contacts from the contact strip or sheet and from each other. The frangible structure can in some embodiments be achieved by creating a weakened region, or a region of stress concentration, in the contact sheet material where the separation must occur. Such a frangible feature may be a sharp or sudden discontinuity in the thickness or width of the material immediately adjacent to, and in connection with, the contact. The stress concentrated or weakened region can be a sharp notch in the width of material section adjacent to the contact, such as a triangular cut outs with one point of the triangle normal to the edge of the material section connecting the contact to the sheet, and the two triangles pointing toward one another. In another embodiment, the frangible section can be created by a partial depth stamping of the material section adjacent to the contact and connected to the contact strip, to create a sharp discontinuity in the thickness of that connecting material section.

In one embodiment, the two dimensional contacts patterned and defined through means described above or through other means, are then configured into the desired three dimensional shape using a forming or other three dimensional shaping process, while the contacts are still attached integrally to the contact sheet or strip. The forming process can be performed en masse, where many contacts or all contacts in an array for one connector are formed simultaneously. In another embodiment, multiple contact arrays for multiple connectors are formed simultaneously using a large forming die or multiple smaller forming dies acting in parallel. Contact forming can also be performed in a series of forming steps, such as in a progressive die arrangement. In one embodiment, the strip is processed through the patterning, forming, plating or surface finishing, molding, contact singulation, and connector singulation in a reel to reel form factor, where the contact strip is very long and rolled out from a starting reel or spool, and then rewound onto an ending reel or spool. The contact strip can be unwound and rewound before, during, and/or after various process steps.

After forming the contacts, the connector body is applied over each array of contacts for an individual connector while the contacts are still integrated into the sheet or strip. The connector body material can be comprised of a polymeric material which is non-conductive. In a preferred embodiment, the connector body is a liquid crystal polymer. In another preferred embodiment, the liquid crystal polymer is applied through a molding process. In another preferred embodiment, the connector housing is over-molded onto the contact sheet after the contacts have been stamped and formed but are still integral to the contact strip. In another embodiment of the present invention, the connector body is applied to the contacts still in strip or sheet form using film assisted over-molding. In another embodiment, a portion of the outer surface of the connector housing has a conductive shield layer to serve as a faradaic cage, to minimize electromagnetic interference with or from other components in an electronic device.

After the connector body is applied to the connector contact array in the strip or sheet format through molding or other methods, the polymer material is fully cured and/or solidified. Subsequently, certain contacts, such as signal contacts, must be singulated from one another and from the contact strip such that they are no longer integral with the contact sheet or strip and are electrically isolated from all other signal contacts and power contacts, so that they are not electrically shorted. This can be accomplished by standard, low cost processes such as stamping, cutting, chemical etching, water jet abrasion, or laser ablation. In a preferred embodiment, all contact singulation is accomplished simultaneously using a stamping die. In another embodiment, in which the attachment point that has maintained the contacts integral to the contact strip or sheet has been made frangible during previous processing, the singulation may be accomplished with a simple die that provides a force adjacent to the frangible section to cause it to fracture and separate. Separation of the connector from the contact sheet or strip can be accomplished in a similar manner to, and in some embodiments, simultaneously with the contact singulation within the connector.

### BRIEF DESCRIPTION OF THE DRAWINGS

FIG. 1 shows a drawing of a perspective view of a 48 position signal connector embodying elements of the present invention.

FIG. 2 shows a drawing of a perspective view of a 28 position power connector embodying elements of the present invention.

FIG. 3 shows a drawing of a schematic view from the top side of the 28 position power connector shown in FIG. 2.

FIG. 4 shows a drawing of a schematic view of the profile of the 28 position power connector shown in FIG. 2.

FIG. 5 shows a drawing of an expanded view of one electrical contact in the 28 position power connector shown in profile view in FIG. 4.

FIG. 6 shows a drawing of a schematic view from the top side of the 48 position signal connector shown in FIG. 1.

FIG. 7 shows a drawing of a schematic view of the profile of the 48 position power connector shown in FIG. 1.

FIG. 8 shows a drawing of an expanded perspective view of the 28 position power connector shown in FIG. 2.

FIG. 9 lists the process steps for one method of manufacture of the connector of the present invention.

FIG. 10 shows a schematic view of the process steps for one method of manufacture of the present invention.

FIG. 11 shows a drawing of a top view of a strip of electrical contacts during an intermediate stage of the manufacturing process for a 28 position power connector, after contact stamping and forming, embodying elements of the novel structure and manufacturing methods of the present invention.

FIG. 12 shows a drawing of a top view of a strip of electrical contacts during a later stage of the manufacturing process for a 28 position power connector than is shown in FIG. 11, after contact stamping and forming and application of the insulative connector body to one connector array, embodying elements of the novel structure and manufacturing methods of the present invention.

FIG. 13 shows a drawing of an expanded view of the sectional area 103 from FIG. 12. FIG. 14 shows a drawing of a profile view of a single electrical contact from the present invention, embodying a compliant, elastic electrical distal contact end and a proximal contact end which can function as a planar solder tail, joined by a contact middle section.

FIG. 15 shows a drawing of a top view of a single electrical contact position from the present invention.

FIG. 16 shows a drawing of a top view of multiple, compliant electrical power or ground distal contact ends ganged together to a smaller number of common solder tails.

FIG. 17 shows a drawing of a profile view of a contact from an alternative embodiment of the present invention, whereby both ends of the electrical contact form separable interconnections to mating terminal pads on a mating circuit element.

FIG. 18 shows a drawing of a top view of the contact from FIG. 17.

FIG. 19 shows a drawing of a profile view of two contacts of the type shown in FIG. 17 after they are embedded in the connector housing and singulated.

FIG. 20 shows a drawing of a profile view of the connector from FIG. 19 after being compressed between two mating circuit elements.

FIG. 21 shows a drawing of a top view of a sub-section of a contact sheet or strip of the present invention, used in the fabrication of a 48 position, surface mounted signal connector, shown after stamping and forming to create the array of three-dimensional electrical contacts. The contacts shown in this drawing are each individually connected with and integral to the contact sheet.

FIG. 22 shows a drawing of an expanded view of a section of the contact array from FIG. 21, showing the stamped and formed contacts and their integral connection to the contact strip.

FIG. 23 shows a drawing of a drawing showing a portion of the contact strip or sheet from FIG. 21 of the present invention for a surface mount connector at a step in the fabrication process where the connector housing is being molded or otherwise deposited over the contact arrays.

FIG. 24 shows a perspective drawing of a finished surface mount connector of the type shown in FIG. 21.

FIG. 25 shows a drawing of a profile view of two contacts of an array of contacts of the type shown in FIG. 14 embedded in a portion of an insulative connector housing, for use in a surface mount connector.

FIG. 26 shows a drawing of a profile view of the surface mount connector of the type shown in FIG. 22 after interconnection with two mating circuit elements.

FIG. 27 shows a schematic of one means of integrating the electrical connector of the present invention to electrically and mechanically interconnect a flexible printed circuit to a printed circuit board (PCB).

FIG. 28 shows a pictorial view of one embodiment of a process flow to manufacture and assemble the separable electrical connectors to interconnect a flexible printed circuit to a printed circuit board.

FIG. 29 shows a drawing of a top view of a connector of the present invention and highlights the support bars in the contact strip that maintain the stamped and formed electrical contacts integral with and connected to the contact strip through stamping, forming, plating, and integration into the connector housing, until singulation when the connections are severed.

### DETAILED DESCRIPTION

In one embodiment of the present invention, a connector has a plurality of electrical contacts, each contact having a distal end, a proximal end, and a middle section, these three sections of each individual contact forming a unitary body. In this embodiment, the middle section of the contact is located within an insulative connector housing, and the middle section is to some extent chemically and mechanically bonded to the connector housing, said housing having been solidified around the middle section of the contact during a molding or other application process, rather than simply being held in place by frictional forces and/or applied pressure. In a preferred embodiment, the connector housing has openings from which an elastic distal end of each of the contacts emanates above the plane of a first surface of the contact middle section and above a first surface of the connector housing. In another embodiment, the distal end of at least one contact emanates above the first surface of the connector housing at an angle of greater than zero degrees and less than ninety degrees, and preferably at an angle of less than 60 degrees, and approximates the shape of an elastic cantilever beam. In this embodiment, the contact distal end serves to make a separable electrical interconnection to at least one conductive terminal on a first surface of a first mating circuit element. In one embodiment of the present invention, the proximal ends of the contacts emanate from a second opposing surface of the middle section of the contact, and protrude slightly above but approximately parallel to the second surface of the connector housing, and function as solder terminals or ‘tails’ for permanent or semi-permanent attachment of the connector to terminals on a mating circuit element.

In another embodiment of the present invention, the proximal end and the distal ends of the contact emanate from opposing first and second surfaces of the connector housing respectively, at angles of greater than zero and less than ninety degrees, and preferably less than 60 degrees, and both function to make separable electrical interconnections to conductive terminals on a first and second mating circuit element, respectively.

According to one embodiment of the present invention, a separable electrical connector for interconnection of circuit elements in an electronic device is comprised of a plurality of electrical contacts that are created from a single strip or sheet of conductive material.

In one embodiment of the present invention, the contacts in the connector are arranged in an area array configuration. The contact shape is defined and formed while the contacts are integral with and attached to the contact strip, and an insulative dielectric connector body is added to the connector before the contacts are separated from the contact strip, so that the diametric true position error of the contacts relative to one another and to registration features on the connector housing is less than 0.250 mm and preferably less than 0.150 millimeter. In a preferred embodiment, the insulative connector body is molded onto the contact sheet. In another embodiment, the insulative connector body is created on the contact sheet through a three dimensional printing process. In a preferred embodiment, the insulative connector body is comprised of a liquid crystal polymer (LCP) molding material.

The contact strip or sheet is preferably comprised of a high conductivity, high strength copper alloy with good fatigue resistance and elasticity, such as copper-beryllium or copper-nickel-tin, with a thickness of 5 to 200 microns, and preferably 25 to 75 microns. This thickness range provides adequate spring load to ensure a suitable electrical connection is provided, without requiring excessive load such that it is not practical for an electrical connector for miniaturized electronics applications. In addition, contact sheet thickness in this range enables creation of fine pitch contact array patterns using stamping or etching, and enables forming of tighter radius contact shapes.

In one embodiment of this invention, the contact sheet is made of a heat-treatable alloy, whereby the hardness yield strength of the material increases after a heat treatment such as a precipitation hardening treatment. In one embodiment of the present invention, the material is fully hardened and heat treated before stamping and forming of the contact elements. In another embodiment of the present invention, the material is stamped and formed before it is fully hardened through heat treatment, and the heat treatment is performed prior to application of the connector housing.

In one embodiment of the present invention, the electrical contacts each have a common shape which approximates the shape of the letter U or C when viewed from a perspective normal to the plane of the connector surface. The contact is fully comprised of formed material from the contact strip or sheet, and includes a proximal end, and a middle section, and a distal end. The contact distal end is moveable elastically and emanates out of the plane of the contact sheet at an angle of less than ninety degrees and greater than zero degrees, and more preferably between 25 and 60 degrees, and approximates the shape of a cantilever beam. The contact also has a middle section which is coplanar with the original plane of the unformed contact sheet, and a proximal end which is parallel to the plane of the contact sheet and slightly raised from the plane of the contact sheet in the opposite direction from which the distal end emanates. The proximal end of the contact in this embodiment functions as a terminal for attachment of the contact to a connection pad on a circuit element using solder or conductive adhesive or similar semipermanent conductive interface as commonly used for surface mount connectors. The proximal end, middle section, and distal end of each contact form a unitary body. In one embodiment of this invention, the contact sheet is formed in part by a rolling process, which imparts a grain direction to the contact sheet. The grain direction of the spring contact sheet is oriented in the same direction in all three sections (distal end, proximal end, and middle section) of each contact, and preferably is parallel to the direction of the long dimension of the distal end of the contact, i.e. is parallel to the elastic cantilever beam. The middle section of the contact is captured and embedded in the insulative connector body during the molding or printing or lamination or other deposition process that causes the connector body or housing to be placed onto the contacts, and the housing is thereby mechanically and chemically bonded to and accurately positioned within the connector body. In one embodiment of the present invention, the insulative connector body is composed of a thermoset polymer, and is cured after being applied to the contact sheet, said curing causing a permanent bonding and attachment of the insulative connector body (housing) to at least a portion of the middle section of the contacts. In another embodiment, the thermoset polymer connector body forms a chemical and mechanical bond to portions of the contacts during curing. In another embodiment of the present invention, the insulative connector body is a thermoplastic polymer, and is solidified after being applied to the contact sheet, said solidification accomplished by cooling the melted thermoplastic and causing a substantially mechanically bonding of the thermoplastic body to at least a portion of the middle section of the contacts. In a further embodiment, the thermoplastic housing forms both a mechanical and a chemical bond to portions of the contact middle sections. In another embodiment, the contact sheet undergoes a pre-treatment process to chemically activate its surface to enhance the chemical bonding of the housing polymer to it. In another embodiment, the contact sheet undergoes a surface roughening treatment to enhance the mechanical bonding of the polymer connector body to the contacts. In another embodiment, both a surface activation treatment and a roughening treatment are applied to the contact sheet to enhance bonding of the connector body to the contact middle sections.

A first surface of the molded connector body defines the mating plane of one surface of the connector, and serves as the mating hard-stop for compression of the compliant distal end of the contact when the connector body bottoms out on the mating circuit element, such as a printed circuit board or flexible printed circuit. The mating plane defined by the molded connector body is parallel to the plane of the contact sheet but sits above it, and the elastic distal end of the electrical contact emanates above the first surface of the connector body. The connector housing has openings from which the distal ends emanate, and into which the distal ends can be compressed without impediment during mating of the connector to a mating circuit element through full compression of the distal ends of the contacts.

In a preferred embodiment, the distal end of the contact remains in the elastic range of deformation through full compression to the point where the connector body bottoms out on the mating circuit element, so that the distal end of the contact can approximately re-attain its original height above the connector body when it is fully separated from the mating circuit element. The distal end of the contact and the proximal end of the contact when viewed from a perspective normal to the connector mating surface are analogous to the ‘arms’ of the letter U or C depending on the orientation from which it is viewed, and one embodiment point in the same direction. In a preferred embodiment, the distal end of the contact is adapted to provide a low resistance separable interconnection to a conductive terminal on a mating circuit element. This adaptation can include plating of a noble metal such as gold over a barrier metal such as nickel. In another embodiment, the proximal end of the contact is adapted to accept solder. This adaptation can include plating of a solderable surface finish such as a noble metal such as gold or palladium over nickel, a solderable non-noble metal such as tin over nickel, use of an oxidation inhibitor on the contact sheet material, such as an organic solderability preservative (OSP) for copper, or other means. If desired, the same surface finish, such as nickel and gold plating, can used on both the distal end and the proximal end of the contact. If desired, the entire contact can be plated with nickel and gold or other common materials. The plating process can be electrolytic, electroless, or immersion in nature, or a combination of these various deposition methods.

In another embodiment of the present invention, the distal end and the proximal end of the electrical contacts are both designed to moveable elastically, and both emanate out of the plane of the of the contact sheet and above the planes of the connector housing surfaces in opposing directions, and at angles less than ninety degrees and greater than 0 degrees from the connector body surface from which they emanate, and preferably at angles between 25 and 60 degrees, such that the connector can separably connect to both circuit elements to which it is mating. In this embodiment, both the distal end and the proximal end of the contact resemble cantilever beams, and they are connected by and integral with the middle section of the contact, each contact's distal end and proximal end and middle section forming a unitary body. When viewed from the top of the contact sheet, normal to one surface of the sheet, the contact distal and proximal ends and its middle section form the approximate shape of a letter U or C. When viewed in a profile section view along the length of the elastic beams, the shape of the contact resembles the letter V.

A series of figures is provided to illustrate some, but not all, embodiments of the present invention.

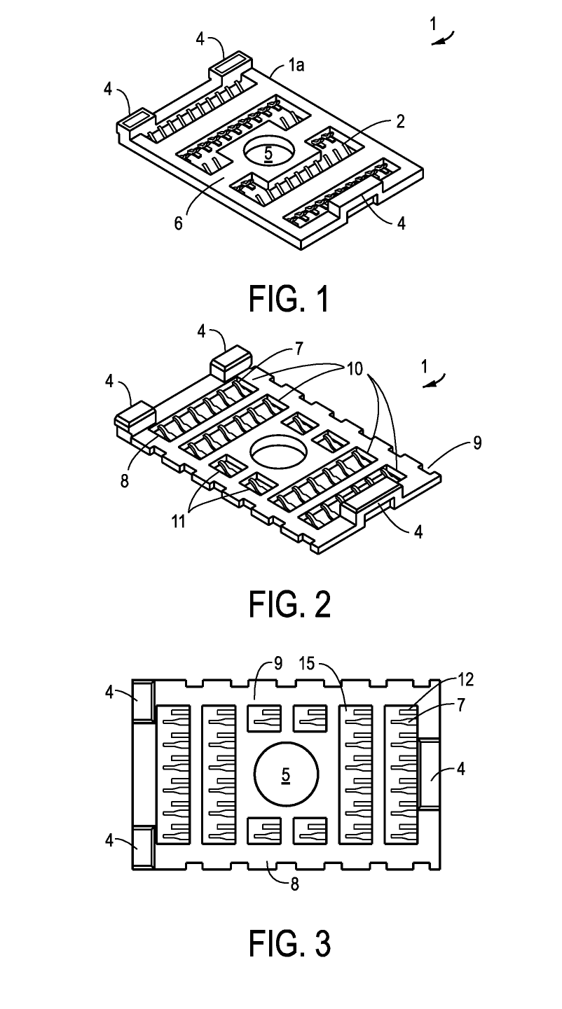

FIG. 1 is a drawing showing a perspective view of a connector 1 according to one embodiment of the present invention. The connector in FIG. 1 has 48 contact positions, and hence can interconnect to 48 terminals on each mating circuit element. Each contact element in this connector is electrically isolated from every other contact element within the connector. Connector body 1A is a molded or printed connector housing comprised of an electrically insulative material such as liquid crystal polymer. Contact distal end 2 is an elastic cantilever beam emanating above the first connector body surface 6. Contact proximal end 3 is a flat attachment point (such as a solder tail) for surface mounting the connector to terminals on a circuit element and is parallel to and slightly proud of a second surface of the connector body, which opposes the first connector surface 6. A middle section of each contact (not visible) is embedded within and bonded to the insulative connector housing 1A. Integrated registration features 4 in connector housing 1A enable precise alignment of the connector to a mating circuit element or clamping structure. Hole 5 shows one embodiment of a means for clamping the connector to a mating circuit element using a screw or stake or rivet or other similar means.

FIG. 2 is a drawing showing a perspective view of a 28 position power connector according to another embodiment of the present invention. Contact distal ends 7 emanate from a plane within the middle of the insulative connector body 9 to a point above the first surface 8 of the connector body. This connector has 28 contact positions, including four rows 10 of six contacts each and two rows 11 of two contacts each. In this example, the contacts in each of the four rows 10 individually are ganged by joining of their middle sections (not visible since they are molded into or encapsulated by the connector body and bonded to the connector body material) together such that they are electrically interconnected with one another in order to improve current capacity of the connector. The four contacts total in rows 11 are each electrically isolated from one another and from the other contacts in the connector, and can serve to interconnect sensing or control circuit terminals for applications such as battery connectors for portable consumer electronics. In a preferred embodiment, contacts in two of the four rows 10 may be used as power connections, and contacts in the other two rows of the four rows 10 may be used as ground or return connections. Integrated registration features 4 enable precise alignment of the connector to a mating circuit element.

FIG. 3 is a drawing showing a top view of the power connector from FIG. 2. Elastic contact distal end 7 is adjacent to contact proximal end 12 of the same contact. Contact proximal end 12 serves as an attachment terminal for soldering or otherwise conductively bonding the contact to a terminal on a mating circuit element permanently or semi-permanently. Contact distal end 7 emanates above a first surface 8 of connector body 9 at an angle of less than ninety degrees but more than 0 degrees, and preferably between 15 and 60 degrees. Connector body 9 has openings 15 which enable the contact distal end 7 to be fully compressed to approximately the plane of connector first surface 8 without interference from the connector body. Contact proximal end is approximately parallel to the plane of the connector surface opposing connector surface 8 and sits slightly proud of it so that it can engage a terminal pad on an mating circuit element without interference. In this embodiment, all of the contact distal ends point in the same direction with respect to the connector body.

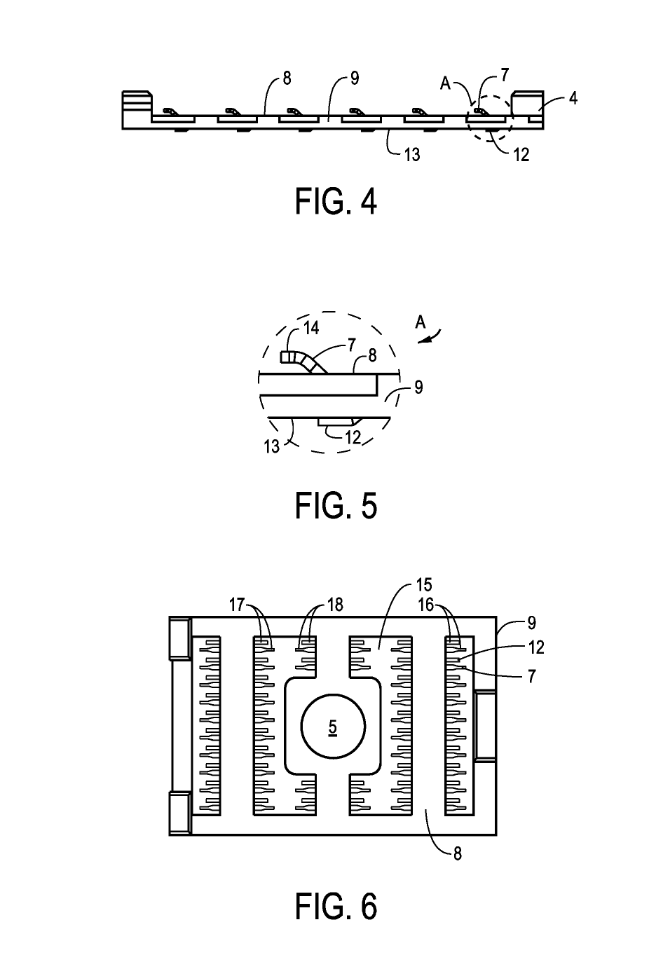

FIG. 4 is a drawing showing a profile view of the power connector from FIG. 2. Contact distal ends 7 emanate above a first surface 8 of connector body 9 at an angle of less than 90 degrees and more preferably at an angle between 15 degrees and 65 degrees. The height which the contact distal end protrudes above surface 8 and the angle at which the distal end emanates is preferably determined through mechanical analysis and measurements or finite element analysis such that the mechanical and electrical working range of the contact is maximized while maintaining the contact spring in its elastic range throughout the entire compression cycle, and minimizing fatigue of the contact material through repeated cycling. Contact proximal end 12 sits slightly above the second surface 13 of connector body 9 and is parallel to the plane of second surface 13. Second surface 13 is preferably parallel to the plane of first surface 8, and to the plane of the middle section of the contact and the plane original contact sheet which is coplanar with the middle section of the contact, as the middle sections of the contacts are molded into the connector body and bonded to it.

FIG. 5 is a drawing showing an expanded profile view of one contact from the 28 position power connector in FIG. 4. Contact distal end 8 emanates above first surface 8 of connector body 9. In this embodiment, contact distal end 7 has a rollover shape 14 at its tip to facilitate sliding of the contact against a terminal pad on a mating circuit element without damage to the contact. The shape of the contact preferably causes the contact to slide forward against a mating terminal on a mating circuit element during normal force compression so that it causes the contact tip to wipe against the terminal pad, breaking through oxide layers or contaminants to produce a low resistance interconnection. Contact proximal end 12 is formed approximately parallel to second surface 13 of connector body 9, and protrudes slightly above it to facilitate surface mount interconnection to a mating circuit element. Connector body 9 has been molded or 3-D printed or laminated or otherwise caused to encapsulate and bond to the contact sheet and middle sections of the contacts such that the planes of the contact sheet and the connector body's first and second surfaces are all parallel.

FIG. 6 is a drawing showing a top view of a 48 position signal connector. Contact distal end 7 of contact 16 emanates from first surface 8 of connector body 9. Contact proximal end 12 of contact 16 is parallel to the plane of a second surface of connector body 9 opposing first surface 8, and protrudes slightly proud of the second surface. Middle section of contact 16 is encased in and bonded to connector body 9 during the molding or printing or otherwise depositing of the connector body and is not visible in this figure, but connects distal end 7 and proximal end 12 and causes the contact to have a U shape and of a unitary structure. The middle section of the contact is coplanar with the original contact strip or sheet. Contacts 17 and 18 illustrate a different contact geometry in this signal connector from the power connector in FIGS. 2-4. Contacts 17 and 18 are oriented in opposing directions, with the distal and proximal ends of contact 17 pointing to the right of the figure, and those of contact 18 pointing to the left. In the power connector in FIGS. 2-4, all contacts point in a single direction relative to the figure.

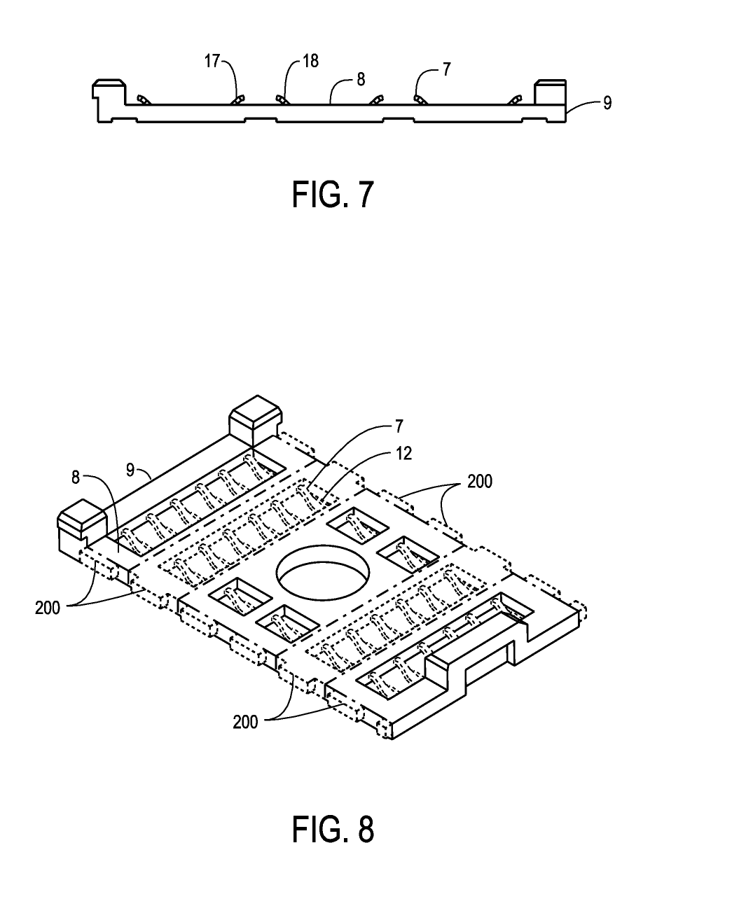

FIG. 7 is a profile view of the 48 position signal connector in FIG. 6. Distal ends of contacts 17 and 18 are oriented in opposing directions. This is but one embodiment of contact orientations in a connector of the present invention, and a variety of combinations of contact directions are feasible in both power and signal connectors of the present invention.

FIG. 8 shows an expanded perspective view of the 28 position power connector shown in FIG. 2 after singulation from a contact sheet or strip. Contact distal ends 7 emanate from a first surface 8 of the molded connector body 9. Contact proximal ends 12 are adjacent to contact distal ends 7. Contact proximal ends 12 emanate from a second surface of connector body 9, opposing the first surface, and are approximately parallel to the plane of the second surface.

Contact sheet tabs 200 formerly held the contact array and the molded connector body integral to the contact sheet or strip, prior to singulation of the connector from the sheet using stamping or other processes. The molded connector housing 9 is shown with a solid outline in this drawing. The conductive contact sheet and contact elements are shown with a hashed outline in this drawing.

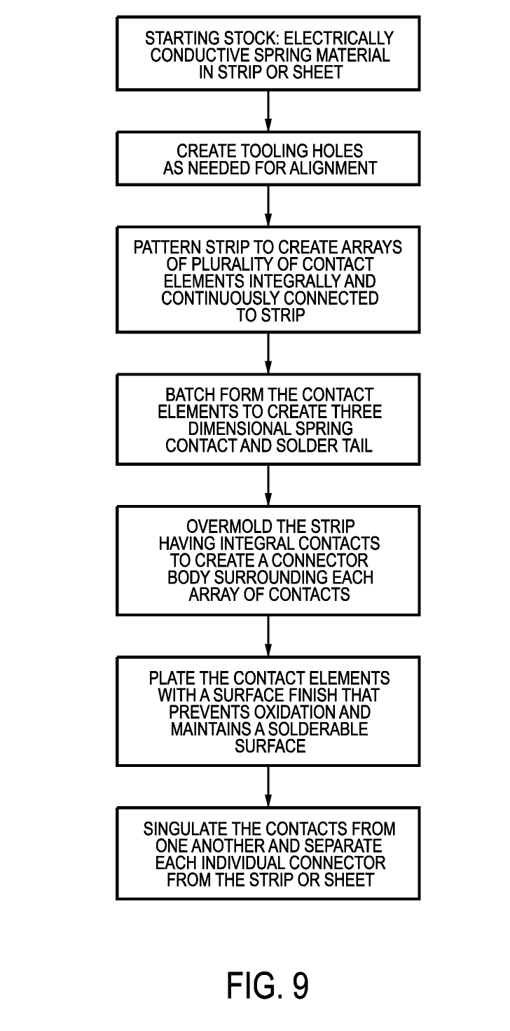

FIG. 9 shows the manufacturing process of a first embodiment of the present invention. An electrically conductive spring material, such as a copper beryllium or copper-nickel-tin alloy is used as a contact material. The metal alloy in sheet or strip form is of a thickness from 5 to 100 microns, and preferably of a thickness from 25 to 75 microns. In strip form, the material may be processed in reel to reel format, so that manufacturing is continuous and highly efficient. In order to facilitate alignment and handling of the contact material, tooling and tractor holes can be created using stamping, punching, or etching processes. Subsequently, the material is patterned to create the two dimensional shape of the contacts, the patterning performed using stamping or etching or other patterning processes. The contact shape is created without removing the contact from the strip or sheet, so that the contact array for each connector remains integral to the contract strip or sheet. In this manner, the alignment of each contact relative to each other in an array remains very precise, and a connector with very accurate true position of the contacts relative to each other and to connector alignment features can be consistently manufactured. Following patterning, the contacts are formed into a three dimensional shape using batch or sequential forming. In a reel to reel strip format, a progressive die may be used for sequential forming steps to create a complex contact shape. The contacts remain integral with the contact strip throughout forming. The forming process creates the generally U-shaped contact with a distal end that emanates from the plane of the contact strip at an angle less than 90 degrees, and preferably from 15 to 65 degrees, and also creates the proximal end which is formed to be approximately parallel to the plane of the contact sheet but slightly proud of the plane of the contact sheet on the opposing surface from which the distal end emanates.

Following forming of the contacts in the sheet or strip, each connector body is created using molding, 3D printing, over-molding, laminating, or other means of depositing or laminating an insulative material to create a connector body. The mold design allows the molding process to capture and bond to the middle section of each contact, but leaves an opening for the elastic distal end of each contact to enable it to be full compressed to the surface of the molded connector body without its movement being impeded. The mold design may also allow for formation of precise alignment features in the connector housing, to enable accurate alignment of the connector to mating circuit elements or to clamping and alignment hardware pre-aligned to the mating circuit element. The molding or other application of the connector body or housing is performed while the contacts are still integral with and connected to the contact strip or sheet. In a preferred embodiment, the contacts are provided with a surface finish in order to resist oxidation and that can accept solder to form a reliable joint on the proximal end and which enables reliable and low resistance separable interconnection to a connection terminal on a mating circuit element. In one embodiment, the surface finish is electroplated hard gold over an electroplated nickel barrier layer. In another embodiment, the surface finish is immersion gold plated over electroless nickel. The nickel thickness in both cases is preferably between 1 and 8 microns, and most preferably between 2 and 5 microns. The gold thickness is between 0.02 and 1.0 microns, and preferably between 0.05 and 0.5 microns. In another embodiment, nickel and gold plating is provided as a surface finish on the distal end of the contacts, and an organic solderability preservative is used on the proximal end. Other noble metals or metal alloys can also be used, such a palladium, platinum, or their alloys. In one embodiment, the surface finish is provided on the contacts prior to molding the connector body onto the contact array. In another embodiment, the surface finish is provided on the contacts after molding the connector body onto the contact array, as shown in FIG. 9, using the connector body to mask the areas where the surface finish is not needed. In yet another embodiment, nickel is plated onto the contact sheet before molding, and gold plating is performed after molding, to reduce the amount of gold plating area and thereby reduce cost. Other surface finishes are also conceivable and are included as embodiments of this invention, such as silver plating or palladium plating, over barrier metals such as nickel. In another embodiment, the surface finish is applied after the connector housing is integrated around the contact array, and the connector is singulated from the contact strip or sheet, using electroless and/or immersion plating.

After surface finishing and application of the connector housing to the contact array, at least some of the electrical contacts must be singulated from one another, and the connector must be separated from the contact sheets. This separation can be done by separating the portions of the contact sheet that are still attached to the contacts, using a process such as stamping, etching, cutting, or laser ablation. In one embodiment, frangible sections are created during the initial patterning and forming of the contact strips or sheets in the regions where the contacts will be separated from the strip and from each other. These frangible sections can consist of thinned or narrowed regions in the contact sheet that substantially reduce the strength and/or increase the stress concentration in those regions, or can be weakened or made more brittle through work hardening or other means. The separation can then be accomplished by stamping the frangible regions with a die or by pushing the connector out of the contact strip or sheet or by other mechanical means.

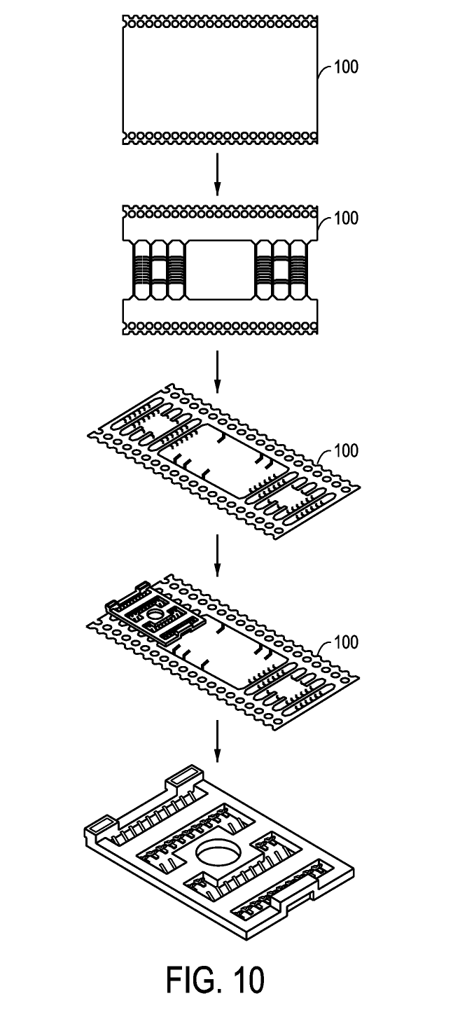

FIG. 10 is a schematic representation of a manufacturing process for the power connector of another embodiment of the present invention. 10A is a top view of a portion of a strip of conductive spring material 100 such as copper beryllium alloy 25 or a copper-nickel-tin alloy such as Materion BF158, although a wide variety of other materials or alloys can also be used. 10A shows the strip with ‘tractor’ features and tooling holes in place for alignment and reel to reel processing. 10B is a top view of the strip from 10A after patterning and forming to create the two and three dimensional shapes of contacts in arrays for the power connector shown in FIGS. 2-4. Two arrays are shown in 10B, but in high volume manufacturing a very long strip in reel to reel format may have hundreds or thousands of contact arrays per strip. 10C is a perspective view of the strip in 10B after forming the contacts into 3 dimensions. The forming can be accomplished with a forming die which forces the contacts to plastically deform into a precisely defined shape determined by the shapes of the faces of the mold or die. It is possible that one array would be formed at a time, or multiple arrays can be formed at one time. It is also possible that portions of an array would be formed sequentially such as in a progressive die set up. FIG. 10D is a perspective drawing showing the strip from 10C after one of the arrays has been over-molded to form its connector body. It is possible that more than one connector array would be over-molded simultaneously. 10E shows the finished connector after singulation and separation from the contact strip.

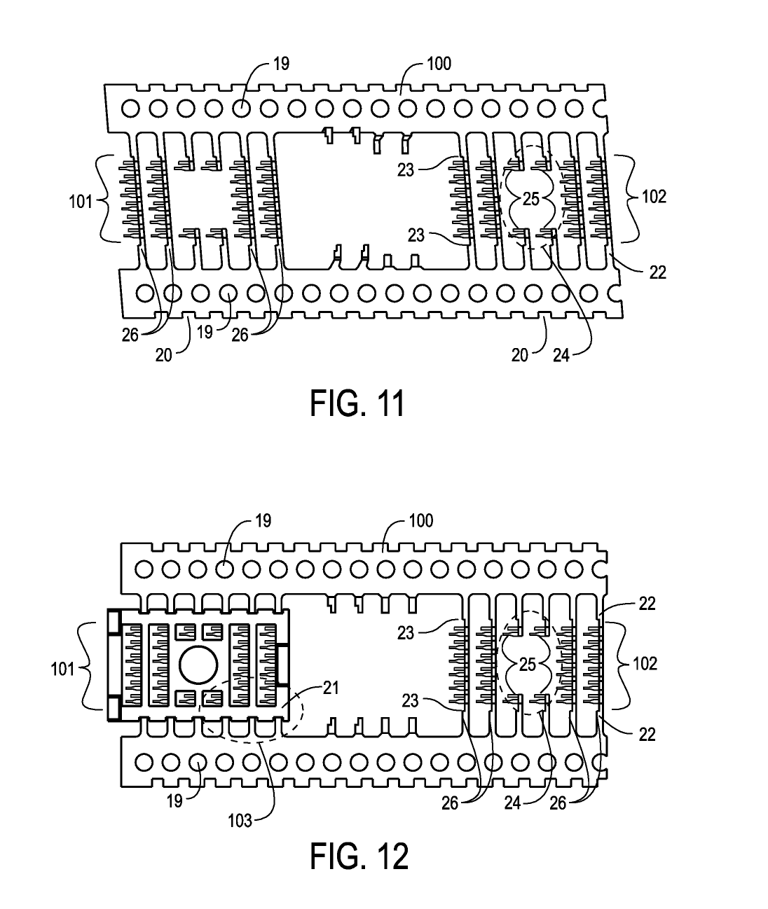

FIG. 11 is a drawing showing a perspective view of the contact strip 100 from 10D showing the contact arrays 101 and 102 for two individual power connectors prior to application of a connector housing. Holes 19 and slots 20 are alignment holes and ‘tractor’ features in strip 100 for use during the fabrication steps of patterning, forming, molding, and singulation, and for moving the strip through the manufacturing operations in continuous reel to reel processing or in individual panels, strips, or sheet formats. 23 are connection points between the contacts or contact rows and the contact sheet or strip, and can comprise optional frangible sections having an abrupt transition in width or thickness of the support tabs 22 that maintain the contacts integral with the contact strip, such that they are easily fractured when deformed with a die due to stress concentration. In many cases, such as where the contact sheet is very thin, these frangible sections with stress concentration or weakened features may not be required, as the singulation may be accomplished easily with a stamping die without a stress concentration or weakening design feature.

Four center contacts 24 in FIG. 11 will each become electrically isolated from all other contacts when the connection points 25 are broken or cut. In one embodiment, the connector arrays 101 and 102 would be used as contacts for a battery power connector, and the four isolated center contacts 24 could be used for monitoring and/or control signals. The six contacts in each of the other four rows of contacts 26 would remain electrically connected to each other within each row (commoned or ganged by row), and the singulation stamping would occur only at the ends of each row of contacts 23. In a preferred embodiment, two of these four rows of contacts in the power connector in FIG. 11 would be used for power connections and two of these four rows of contacts would be used for ground or return current.

FIG. 12 is a drawing showing a top view of the contact strip 100 from FIG. 11 showing the contact arrays 101 and 102 for two individual power connectors after application of a connector housing 21 to array 101 but before application of a connector housing to array 102. 23 are connection points between the contacts or contact rows and the contact sheet or strip, and remain connected to and integral with the support tabs 22 that are part of the contact strip 100. Subsequent to this manufacturing step, a connector housing will be molded over or otherwise attached to the next contact array 102. In an alternative embodiment, a plurality of contact arrays may be over-molded or have the connector housings otherwise attached and bonded simultaneously.

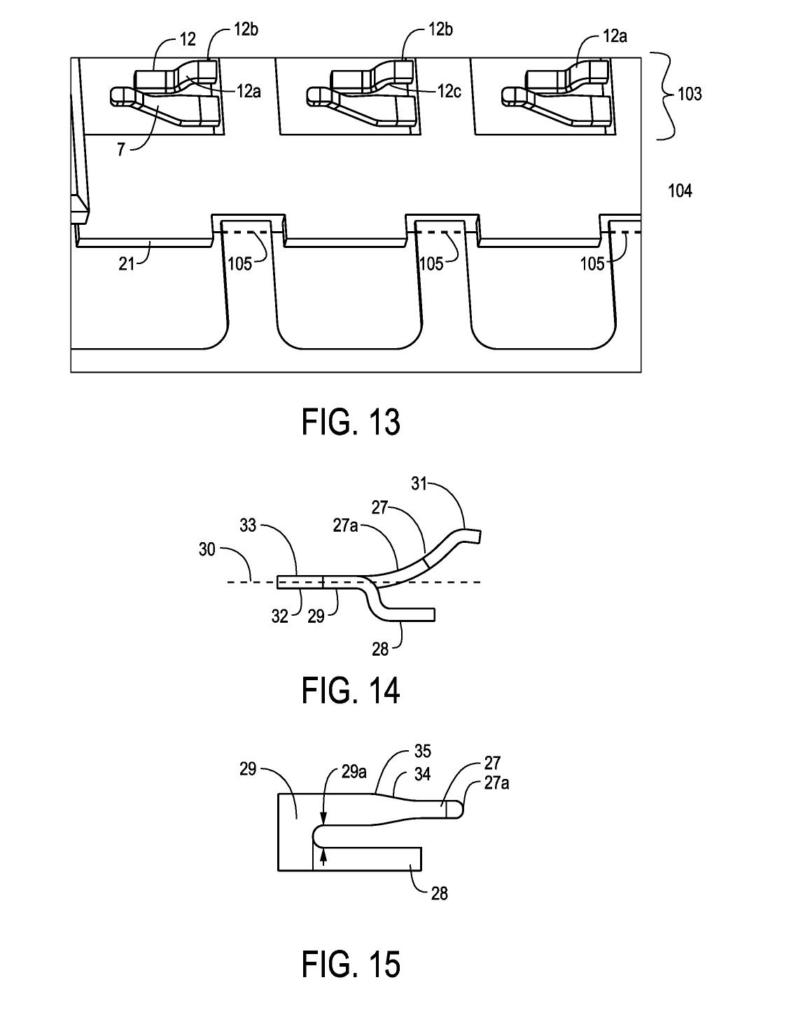

FIG. 13 is a drawing showing an expanded perspective view of the in-process power connector from FIG. 12 showing 3 contacts, highlighted as contacts 103 in FIG. 12 and FIG. 13. Middle sections of contacts in FIG. 13 have already been encased in and bonded to a connector housing 21. Distal contact end 7 and proximal contact end 12 emanate outward from the connector housing 21 in opposite directions (distal end 7 upward and proximal end 12 downward), and both have ends pointing to the left as shown in this figure. Proximal contact end 12 extends below a bottom surface of the connector housing but is substantially parallel to the plane of the bottom surface of the connector housing. Proximal contact end 12 has a bend 12A where the contact transitions from a region 12B where it is approximately coplanar with the contact strip to a region 12C where it is protruding outward from the contact sheet (downward in this drawing) at an angle of less than 90 degrees, and greater than 65 degrees, this steep angle and geometry causing the proximal end to behave approximately like a rigid, non-elastic body under downward, normal force pressure. Distal contact end 7 emanates above a top surface 104 of the connector housing 21, at an angle of less than 90 degrees but more than 10 degrees, and preferably more than 30 degrees. In reality, the take-off angle of the distal end of the contact may increase gradually, forming an arc of increasing angle for some portion of its length. Middle section of contacts 103 are each encapsulated in and bonded to the insulative connector housing, and held in place by the housing permanently. Separation points 105 are the locations where the ends of each row of contacts will be separated from the contact strip after the connector housing has been applied to the contact strip and the connector fabrication is complete. Separation points 105 can be cut or broken or otherwise separated using a stamping die, a punch, a laser, chemical etching, an abrasive water jet, or by other means. In a preferred embodiment, all separation points for a connector array are separated simultaneously using a custom stamping die.

FIG. 14 is a drawing showing a profile view of an individual contact after patterning, forming and singulation for one embodiment of the present invention. Distal end 27 emanates from the central plane 30 of the contact sheet at an angle of less than 90 degrees, and preferably less than 60 degrees, and functions as a cantilever beam-like contact spring. In one embodiment, the angle of distal end emanating from the plane of the contact sheet changes along the length of the distal end, and initially describes an arc 27A. Distal end 27 has an optional rollover tip 31 to facilitate sliding of the contact distal end tip during compression of the contact distal end against a terminal pad on a mating circuit element. Proximal end 28 is formed approximately parallel to the plane of the contact sheet and emanates below the surface 32 of the contact sheet opposing the surface 33 from which the distal end 27 emanates. Contact middle section 29 remains in the plane of the contact sheet or strip, and is captured in and bonded to the connector body (not shown for clarity) to secure the contact prior to singulation.

FIG. 15 is a top view of an individual electrically conductive contact of one embodiment of the present invention where the connector is a surface mount connector, shown here subsequent to patterning, forming, molding and singulation of the contact. The connector housing is not shown in this drawing so the details of the contact structure can be seen clearly. In a typical embodiment of this invention, there would be a plurality of these contacts in a connector housing, with the middle section 29 of the contacts captured and retained by and bonded to or adhered to the material of the housing. Distal end 27 of the contact serves as a cantilever beamlike contact spring and proximal end 28 serves as a solder terminal or ‘tail’ for surface mount attachment of the contact to a terminal pad on a mating circuit element. Distal end 27 and proximal end 28 point in the same direction and comprise a substantially U-shaped or C-shaped appearance in conjunction with the connecting middle section 29. In a preferred embodiment, distal end 27 has a taper 34 in top view from the ‘hinge point’ 35, the hinge point being where the contact flexes maximally during compression, toward the contact distal end tip 27A to approximate a constant stress beam design, minimizing stress concentration and maximizing fatigue life of the contact. Distal end 27 and proximal end 28 are joined by middle section 29, and are adjacent to each other in a top view, with gap 29A separating them. When the connector containing contacts as shown in FIG. 15 is mated to two circuit elements, the mating terminal pads of the two circuit elements corresponding to the distal and proximal ends of the contact would be offset from each other by a pitch whose distance would be approximately equal to the sum of the gap 29A plus one half of the width of the contact distal end plus one half the width of the contact proximal end.

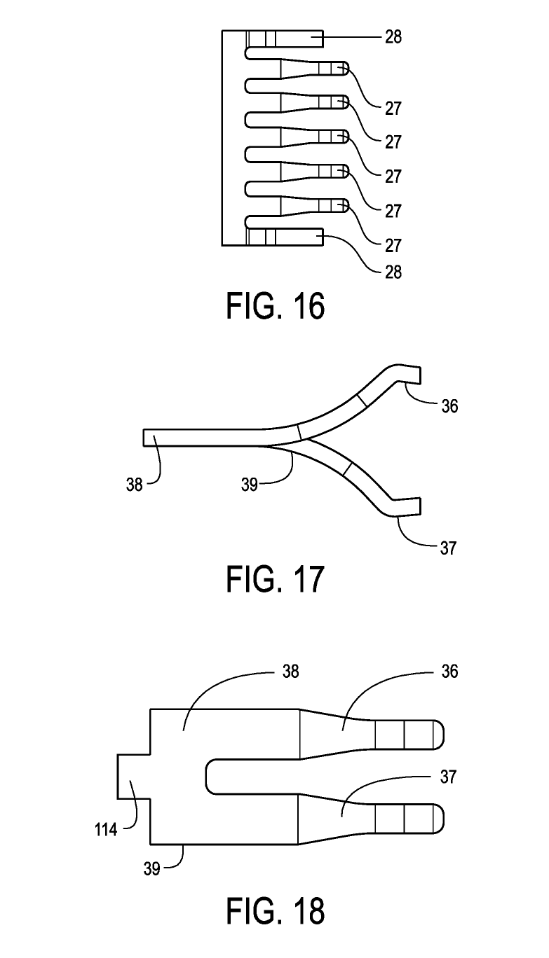

FIG. 16 is a top view of an alternative embodiment for a row of ganged power contacts for a power connector. Whereas in FIG. 11 each of the power contacts of rows 26 have their own proximal end for soldering to terminal pads on a mating circuit element, the row of contacts in FIG. 15 utilizes fewer than one solder tail 28 (proximal ends 28) for each elastic contact (distal ends 27). This enables more power connections in a given area, enabling miniaturization of the connector and/or higher current carrying capacity. This is facilitated by the fact that the soldered connections of proximal ends 28 typically have lower contact resistance than the separable connections of distal ends 27 to mating terminals on a mating circuit element. Various other configurations of ganged power contacts, including various ratios of distal ends and proximal ends, are alternative embodiments of the present invention.

FIG. 17 is a profile view of an electrically conductive contact 39 from an alternative embodiment of the present invention, wherein both ends of the electrical contact form separable interconnections to mating terminal pads on opposing mating circuit elements. The contact 39 has a middle section 38 which is coplanar with the original plane of the contact sheet, a distal end 36 and a proximal end 37. Both distal end 36 and proximal end 37 are cantilever beam-like spring contacts that are designed to separably mate to terminal pads on circuit elements. Distal end 36 is intended to separably mate to a terminal pad on a first circuit element, and proximal end 37 is intended to separably mate to a terminal pad on a second circuit element. In a preferred embodiment, the distal end and the proximal end have approximately the same contact shape and thickness, and when compressed by equal amounts would provide similar force to the mating terminal pads on the first circuit element and the second circuit element for an equal amount of compression distance. Contact 39 would typically be one of a plurality of contacts of similar design in an array or row of contacts in a connector. The plurality of contacts would be encompassed within a connector body made of an insulative material, such as a liquid crystal polymer (LCP) molding compound or other molding compound or laminate-able or depositable material. The connector body would capture and surround and bond or adhere to a significant portion of the middle section 38 of each contact in the array. The connector body would be molded or otherwise deposited on the contact array while the contacts were still integral with, and connected to, the contact sheet or strip, and then the contacts would subsequently singulated as needed to allow the connector to function properly in a given application.

FIG. 18 is a drawing showing a top view of the contact 39 from FIG. 17. Distal end 36 emanates upward from the page as drawn, and proximal end 37 emanates downward into the page as drawn. Contact middle section 38 preferably remains in the original plane of the contact sheet or strip, and would be encapsulated in and bonded or adhered to the connector housing insulative material (not shown) after contact stamping, forming, and either before or after contact plating. In a preferred embodiment, distal end 36 and proximal end 37 have the same 2 dimensional and 3 dimensional geometry, and exhibit the same spring constants. Contact middle section 38 may have a tab 114 protruding in the opposite direction from the proximal and distal ends of the contact 36 and 37, which may be used to maintain the contact integral to the contact strip or sheet until singulation of the contact and the connector from the strip.

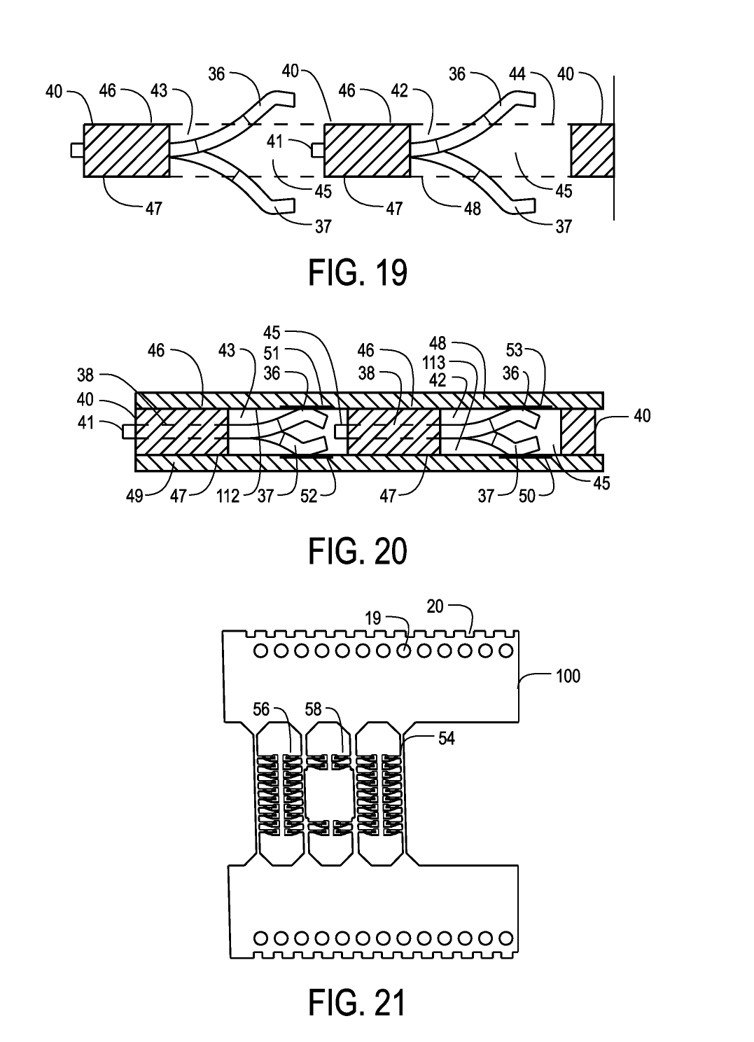

FIG. 19 is a drawing showing a profile view of two contacts 42 and 43 of the type shown in FIGS. 17 and 18 after they are molded into an insulative connector body 40. Contacts 42 and 43 have distal ends 36 and proximal ends 37 which are all elastic cantilever beam-like springs designed to mate separably to terminal pads on mating circuit elements. Insulative connector body 40 is molded or otherwise deposited so as to encapsulate and bond to a significant portion of the middle sections of contacts 43 and 42. Connector body 40 has openings 45 from which the proximal ends 36 and distal ends 37 of contacts 43 and 42 protrude above opposite surfaces 46 and 47 of the connector body. Openings 45 in the connector body enable the elastic distal ends 36 of the contacts 42 and 43 to move freely when compressed fully to the plane 44 of the first surface 46 of the molded connector body, and also allow the elastic proximal ends 37 of the contacts 42 and 43 to move freely when compressed fully to the plane 48 of the second surface 47 of the molded connector body. Connector body surfaces 46 and 47 act as hard stops to prevent over-compression of the elastic distal and proximal ends of the contact elements. When the connector is mated between two circuit elements using normal force to the opposing surfaces 46 and 47 of the connector body 40, the surfaces 46 and 47 of the connector body 40 will bottom out on the surface of the mating circuit elements, halting further compression of the contact. The molded connector body preferably protrudes an equal amount above the top and bottom surfaces of the middle section of the contacts, and the distal and proximal ends of the contact 36 and 37 preferably protrude an equal distance above connector body surfaces 46 and 47 respectively, so that the maximum displacement of the elastic contact ends 36 and 37 are the same on both sides of the connector. In a preferred embodiment of the present invention, the height of the elastic contact ends above the connector body is designed so that the contact remains in the elastic range throughout its full range of compression, thereby preventing plastic deformation of the contacts. A tail portion 41 of the middle section of the contacts may protrude from the back of the openings 45 of the connector body 40. In one embodiment of the present invention, this tail portion is connected to and remains integral with the contact strip or sheet during patterning and forming of the contacts and molding or otherwise depositing of the connector body over the contact array. This tail portion 41 of the middle section of the contact is then singulated from the contact sheet to free the connector from the contact sheet and to electrically isolate contacts from one another.

FIG. 20 is a drawing showing a profile view of the two contacts 42 and 43 in an insulative connector body 40 from FIG. 19 after the connector has been compressed between two mating circuit elements 48 and 49. Contacts 42 and 43 have distal ends 36 which are elastic cantilever beam-like springs which have been compressed against and separably mated to terminal pads 51 and 53 on circuit element 48. Contacts 42 and 43 have proximal ends 37 which are elastic cantilever beam-like springs which have been compressed against and separably mated to terminal pads 50 and 52 on circuit element 49. Circuit elements 48 and 49 can be rigid or flexible printed circuit boards, or other electronic substrates such as semiconductor packages substrates. If one or both of these mating circuit elements are flexible printed circuits, they preferably have stiffening elements bonded to the back side of the circuit away from the connector, to aid in the uniform application of force to the array of elastic contacts of connector body 40. Terminal pads 50, 51, 52, and 53 are conductive terminals on the circuit elements. They are preferably copper terminals with a surface finish which prevents oxidation, but can also be comprised of other conductive materials. In a preferred embodiment, these terminal pads are copper over-plated with nickel and hard gold. In another embodiment, these terminal pads are copper over-plated with electroless nickel and immersion gold. Connector body 40 has openings 45 into which the proximal ends 36 and distal ends 37 of contacts 43 and 42 can be compressed to the level of the opposite surfaces 46 and 47 of the connector body when mated compressively against circuit elements 48 and 49 respectively. Openings 45 in the connector body 40 enable the elastic distal ends 36 of the contacts 42 and 43 to move freely when compressed fully by mating circuit element 48 to the plane 44 of the first surface 46 of the molded connector body, and also allow the elastic proximal ends 37 of the contacts 42 and 43 to move freely when compressed fully by mating circuit element 49 to the plane 48 of the second surface 47 of the molded connector body. Connector body surfaces 46 and 47 act as hard stops to prevent overcompression of the elastic distal and proximal ends of the contact elements. When the connector is mated between two circuit elements 48 and 49 using normal force to the opposing surfaces 46 and 47 of the connector body 40, the surfaces 46 and 47 of the connector body 40 will bottom out on the surface 112 of the mating circuit element 48 and the surface 113 of mating circuit element 49 respectively, halting further compression of the contact and preventing overcompression and plastic deformation of these contacts. In a preferred embodiment, compression of the distal and proximal contact ends 36 and 37 against mating pads 50, 51, 52, and 53 causes a wiping action of the contact tip against the mating pad to break through contaminants or oxide films and achieve a low resistance interconnection. Preferably, the surface finish on the contact ends 36 and 37 and mating terminal pads 50, 51, 52 and 53 are electroplated hard gold over nickel, to minimize wear of the surface finish during repeated mating and un-mating cycles. In another embodiment, the surface finish on the contact ends is immersion gold over electroless nickel. Other conductive surface finishes can also be utilized in the present invention.

FIG. 21 is a drawing showing a full width but partial length portion of a contact strip used in the structure and method of manufacturing of the present invention. Strip 100 with alignment and tractor features 19 and 20 has contacts 58 with attachment points 56 connected with and integral to support sections 54 which themselves are integral to and a unitary part of the contact strip. In this design, each contact has its own discrete connection to the contact strip after patterning, and by severing each of these connections after the connector housing is applied to the contact array, each contact can be electrically isolated from all other contacts.

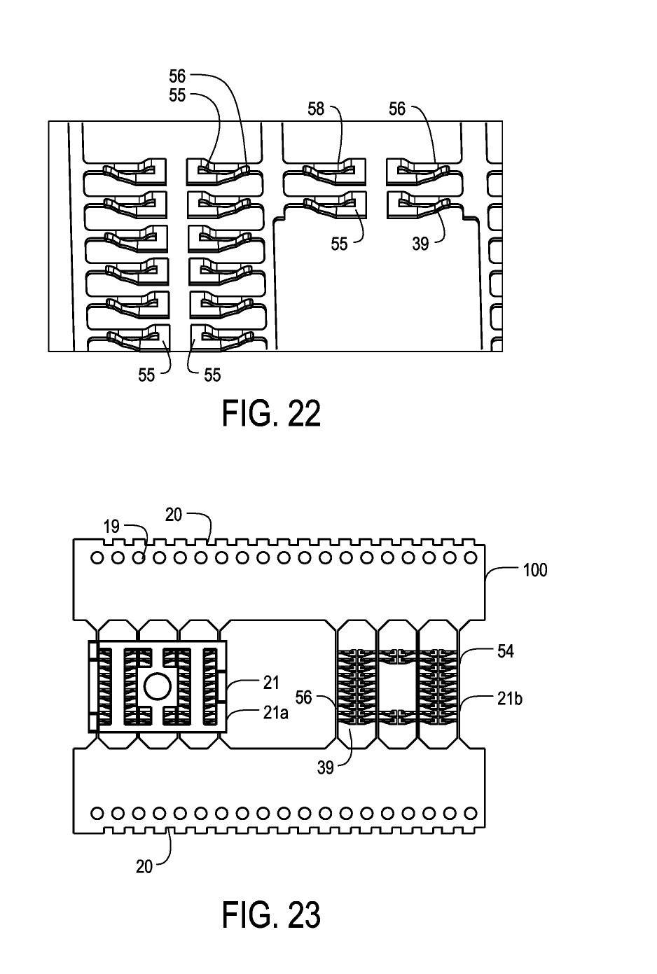

FIG. 22 is a drawing showing an expanded view of a portion of a contact strip or sheet from FIG. 21 of the present invention for a surface mount connector. In this connector array, each individual contact 39 has its own attachment point 56 to a support section 54 integral to the contact strip or sheet. After the insulative connector housing is deposited or applied or molded over the contact array (not shown), each individual contact 39 is singulated (separated from) the contact sheet or strip at the attachment points 56. The singulation can be accomplished in a parallel fashion using a stamping die that selectively cuts each attachment point 56 simultaneously. Alternatively, the singulation can be accomplished in a sequential fashion, using other means such as laser cutting or stamping. The contact array shown in FIG. 22 can be effectively used for a connector where a majority of the contacts are used to make signal connections, whereby the contacts must be electrically isolated from all other contacts. In this connector array, each individual contact 39 has its own attachment point 56 to the contact strip or sheet. After the insulative connector housing is deposited or applied or molded over the contact array, each individual contact 39 is singulated (separated from) the contact sheet or strip. The singulation can be accomplished in a parallel fashion using a stamping die that selectively cuts each attachment point 56 simultaneously. Alternatively, the singulation can be accomplished in a sequential fashion, using other means such as laser cutting or stamping. In the connector array partially shown in FIG. 22, the attachment point of each contact to the contact strip is at the terminus 56 of each proximal end of the contact, each proximal end being a terminal for engaging electrically and mechanically to a terminal on a mating circuit element through a surface mount process like soldering or conductive adhesive bonding.

FIG. 23 is a drawing showing a portion of the contact sheet 100 of the present invention of the type shown in FIG. 21, after patterning and forming to create a plurality of arrays of electrical contacts 39, attached to and integral with support sections 54 which are attached to and integral with contact sheet 100. The connector array on the left side 21A is shown after molding or otherwise depositing of the connector housing 21 onto the contact sheet, whereas the array on the right side 21B is shown prior to application of the connector housing. The contacts 39 of this array are designed to be electrically isolated from all other contacts in the array after the connector housing is applied to the array and the singulation process is performed. The connector housing 21 was molded over, deposited on, laminated to, printed on, or otherwise formed over the middle sections of the individual contacts in the contact array 21A, and openings in the housing enable the elastic distal ends of the contacts to move freely during compression of the connector for electrical and mechanical mating to a mating circuit element. The singulation process can consist of a stamping process or other process such as cutting, etching, laser ablation, or machining. In a preferred embodiment, a stamping die cuts all of the contacts free of the contact sheet in one stroke. Alternatively, the singulation process can make use of a progressive die whereby a portion of the contacts in each array are singulated at each progressive die station.

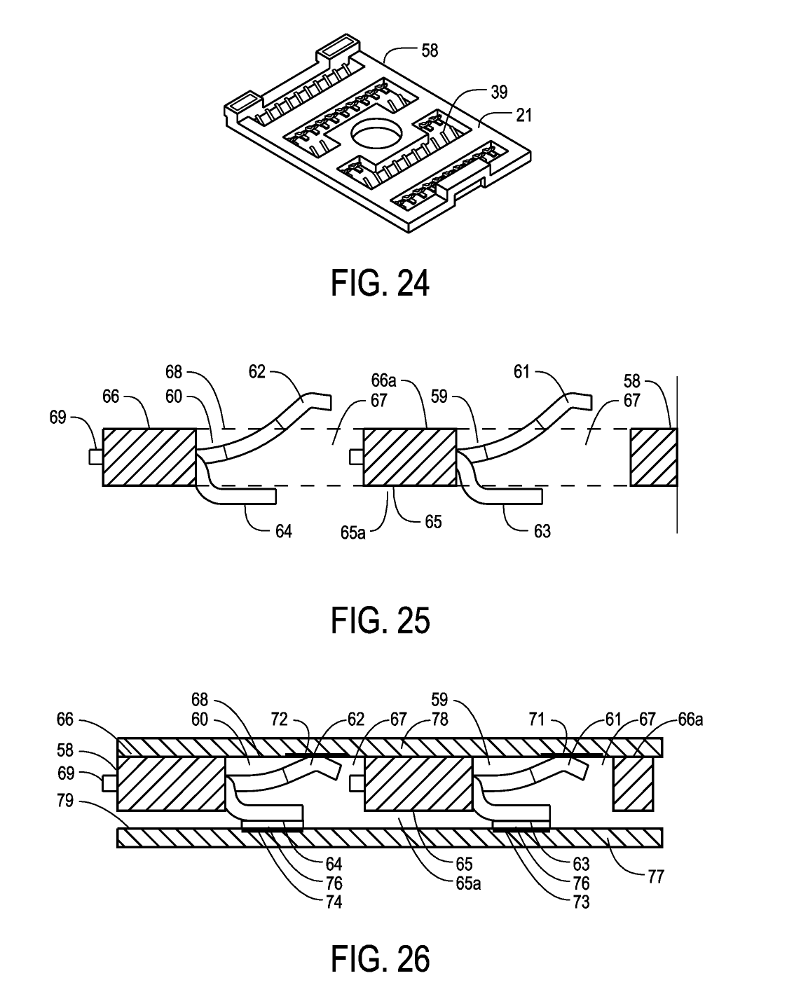

FIG. 24 is a drawing that shows the connector array 21A from FIG. 23 as a finished surface mount connector 58 after singulation. Each contact 39 can be electrically isolated from all other contacts to allow functional signal interconnections without shorting to other circuits. 21 is the insulative connector housing.

FIG. 25 is a drawing showing an expanded profile view of two contacts 59 and 60, of a plurality of contacts that would be in a typical connector of one embodiment of the present invention, of a type shown in FIGS. 14 and 15 for use in a surface mount connector, whereby a first side 66A of the connector makes a separable electrical connection to a first mating circuit element (not shown), and a second opposing side 65A of the connector makes a semi-permanent or permanent electrical connection to a second mating circuit element (not shown) using solder or conductive adhesive or by other means that mechanically attaches it while electrically connecting it through the proximal contact ends 63 and 64. Contacts 59 and 60 have middle sections (not shown) which are encapsulated into an insulative connector body 58. Contacts 59 and 60 have distal ends 61 and 62 respectively, and proximal ends 63 and 64 respectively. Contact distal ends 61 and 62 are elastic cantilever beam-like springs designed to mate separably to conductive terminal pads on mating circuit elements, and distal ends 61 and 62 emanate above the first surface 66 of insulative connector body 58. Contact proximal ends 63 and 64 are approximately parallel to the plane of the second surface 65 of the connector insulative body 58, and preferably protrude slightly above the second surface 65. Proximal ends 63 and 64 are adapted to accept a solder joint, or other permanent connection material, such as conductive adhesive, to attach them to conductive terminal pads on a mating circuit element. Insulative connector body 58 is molded or otherwise deposited or attached to contacts in the array including contacts 59 and 60, so as to encapsulate a majority of the middle sections of contacts 59 and 60 and other contacts in the array (not shown). Connector body 58 has openings 67 from which the distal ends 61 and 62 of contacts 59 and 60 protrude above a first surface 66 of the connector body 58. Openings 67 in the connector body 58 enable the elastic distal ends 61 and 62 of the contacts 50 and 60 to move freely when compressed fully to the plane 68 of the first surface 66 of the molded connector body. Connector body surface 66 acts as a hard stop to prevent overcompression of the elastic distal ends of the contact elements. When the connector is mated between two circuit elements using normal force to the first surface 66 of the connector body 58, the first surface 66 of the connector body 40 will bottom out on the surface of the mating circuit element, halting further compression of the contact. In a preferred embodiment of the present invention, the height of the elastic contact distal ends above the connector body is designed so that the contact remains in the elastic range throughout its full range of compression, thereby preventing plastic deformation of the contacts. A tail portion 69 of the middle section of the contacts may protrude from the back of the openings 67 of connector body 58. In one embodiment of the present invention, this tail portion is connected to and remains integral with the contact strip or sheet during patterning and forming of the contacts and molding or otherwise depositing or integrating of the connector body over the contact array. This tail portion of the middle section of the contact is then singulated from the contact sheet to free the connector from the contact sheet and to electrically isolate contacts from one another as needed for proper connector function. In another embodiment of this invention, the contacts remain integral with the contact sheet during stamping, forming, plating, and over-molding or other means of connector housing integration, through a connection to the tip of the proximal end of the contact to portions of the contact strip or sheet. Attachments in other regions of the contact are also possible and are incorporated into this invention.

FIG. 26 is a drawing showing an expanded profile view of a portion of a surface mount connector of one embodiment of the present invention. Two contacts 59 and 60, of a plurality of contacts that would be in a typical connector of one embodiment of the present invention, are shown in the fully mated configuration for the surface mount connector of the type shown in FIG. 12. A first side 66A of the connector has been separably electrically connected to a first mating circuit element 78 by applying normal force between the connector 58 and the first mating circuit element 78. The distal ends 61 and 62 of contacts 59 and 60 have been aligned to and compressed against mating pads 71 and 72 of first circuit element 78. Sufficient normal force is applied to fully compress the elastic distal ends 61 and 62 of the contacts. Over-compression of the spring contacts is prevented by the first surface 66 of connector body 58 making contact and bottoming out on a first surface 68 of mating circuit element 78, due to a design of the connector that takes into account the angle at which the distal end of the contact emanates from the connector body, the height of the distal end above the connector body, and the thickness of the connector body (or height above the neutral plane or center of the middle section of the contact). A second side 65A of the connector has been permanently or semi-permanently attached to a second mating circuit element 77 using solder, conductive adhesive, or some other permanent or semi-permanent means 76 to connect proximal ends 63 and 64 of contacts 59 and 60 to conductive terminal pads 73 and 74 on mating circuit element 77. In a preferred embodiment, the connector is first surface mounted on mating circuit element 77 and electrically and mechanically interconnected to terminal pads 73 and 74 on a first surface 79 of circuit element 77, using solder 76 or conductive adhesive or other means, and subsequently the connector is separably mated to mating circuit element 78 by applying normal force. Circuit element 77 may be a flexible printed circuit, or a rigid printed circuit board, or other circuit element. Circuit element 78 may be a rigid printed circuit board, or a flexible printed circuit, or another circuit element such as a semiconductor package substrate. Openings 67 in the connector body 58 enable the elastic distal ends 61 and 62 of the contacts 59 and 60 to move freely when compressed fully by mating circuit element 78 to the plane of the first surface 66 of the molded connector body 58. First surface 66 of connector body 58 acts as a hard stop to prevent overcompression of the elastic distal ends 61 and 62 of the contact elements 59 and 60. When the connector is mated between two circuit elements 77 and 78 using normal force to the opposing surfaces 65 and 66 of the connector body 58, the surface 66 of the connector body 58 will bottom out on the surface of the mating circuit element 78, halting further compression of the contact and preventing over-compression. Proximal ends 63 and 64 of contacts 59 and 60 are designed to have a shape which does not compress significantly under the normal force required to fully compress the elastic distal ends 61 and 62 of the contacts 59 and 60. In a preferred embodiment, compression of the distal contact ends 61 and 62 against mating pads 76 causes a wiping action of the contact tips against the mating pad to break through contaminants or oxide films and achieve a low resistance interconnection.

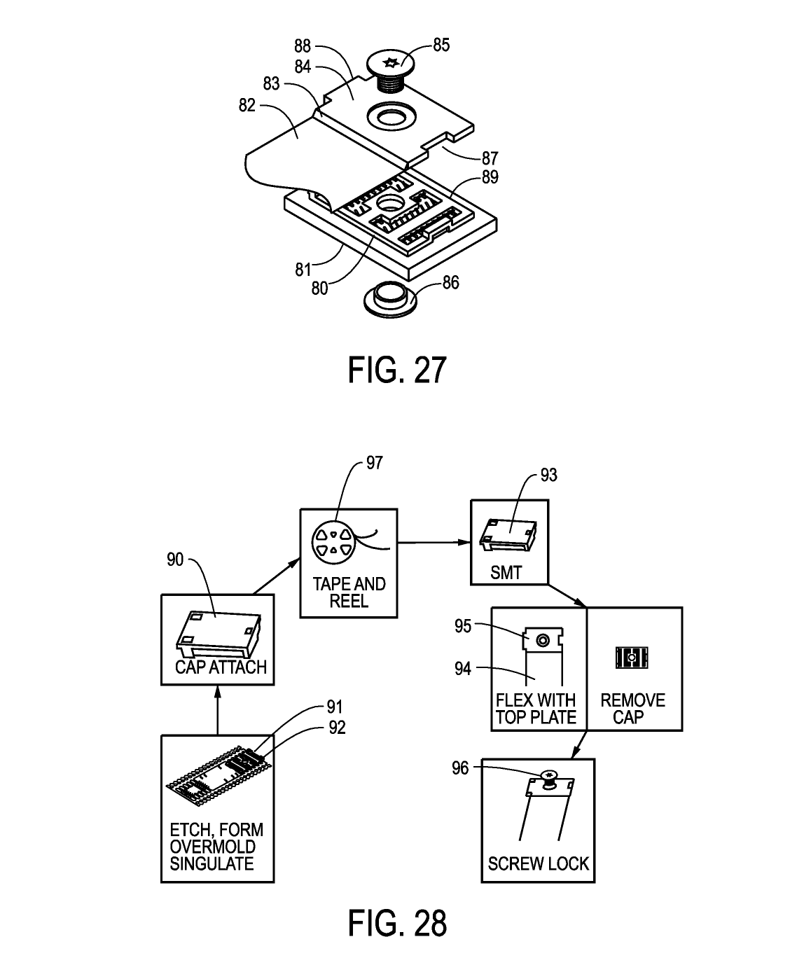

FIG. 27 shows one means of applying normal force to a connector of the present invention in order to form an electrical and mechanical interconnection between two electrical circuit elements. In this embodiment, flexible printed circuit 82 is interconnected to printed circuit board 81 using surface mount connector 80, which is a connector of one embodiment of the present invention. Connector 80 is a surface mount connector permanently attached to printed circuit board 81 using solder interconnections between the distal ends of the contacts of the connector and conductive terminals on the printed circuit board. Alternatively, it may be attached using conductive adhesive. Flexible printed circuit 82 has a stiffener 84 attached to it using adhesive 83. The stiffener is a rigid material and is designed to provide uniform force to the area of the connector during mating using small screw 85 and nut 86. Normal force is applied by screwing the flexible printed circuit assembly with stiffener down to the printed circuit board using screw 85 and nut 86. There are concentric holes in the stiffener, flexible printed circuit, adhesive, connector, and printed circuit board to accommodate the screw. Alignment of the connector to the printed circuit board can accomplished using pick and place equipment during the surface mount assembly process, with optical alignment fiducials as in standard surface mount processing. In one embodiment of the present invention, alignment of the flexible printed circuit assembly to the connector is accomplished by alignment slots 87 and tabs 88 in the edge of the stiffener, which correspond to alignment features 89 in the connector body.

FIG. 28 shows one embodiment of the process flow that may be used to fabricate the connectors of the present invention and assemble them into an electronic system to interconnect a flexible printed circuit to a rigid printed circuit board. In this embodiment, a cap 90 is placed over a first surface 91 of the connector 92 to protect the elastic distal ends during assembly and to provide a flat surface for pick and place of the connector during surface mount processing to solder or adhesively bond the connector to a printed circuit board 93. In this embodiment, the connector and cap are placed in a tape and reel packaging configuration 97 to enable automated surface mount assembly (SMT) of the connector onto a printed circuit board. Subsequent to surface mount assembly, the cap 90 is removed from the connector 92, flexible printed circuit 94 with stiffener 95 is aligned to the connector, and attachment and normal force is applied with screw 96.

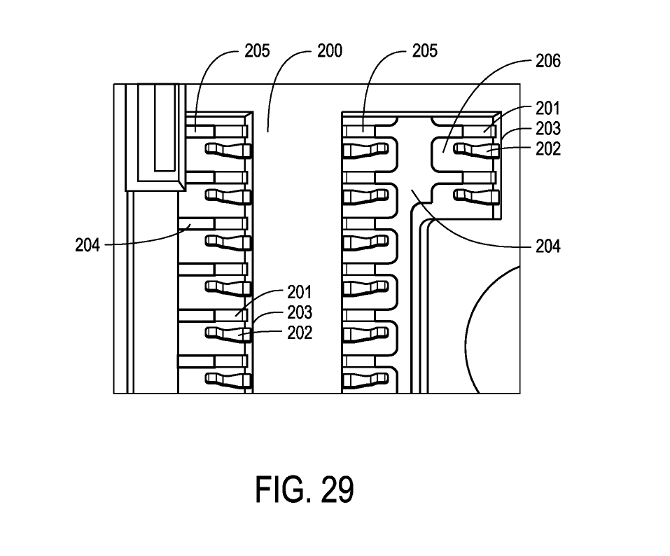

FIG. 29 shows an expanded view of a partial contact array of the present invention. Connector housing 200 has been applied to the contact strip, while contact distal ends 202 and proximal ends 201 are exposed in and emanate from openings 206 in the housing while middle section 203 (not visible) of contacts is embedded in and affixed and bonded to connector housing 200. Contact strip support bars 204 are integral with and connected with contact sheet and with proximal ends of contacts 201. Contact strip support bars 204 are separated from contact proximal ends 201 at separation points 205 after connector fabrication, including connector housing integration, is complete. In a preferred embodiment, all the separation points are severed at one time, preferably using a stamping die.

The preferred embodiment of the present invention has been described with some particularity in the preceding description of the preferred embodiment and some alternative structure and methods of manufacture have been presented within this description. Those of ordinary skill in the relevant art will appreciate that many modifications and substitutions can be made without departing from the spirit of the present invention. For example, the individual contacts can be separated from the sheet in a variety of different ways such as laser separation or singulation or stamping. The structure of the individual electric contact elements and the material from which they are formed can also a matter of design choice and, if a conductive material is added to the contact, the portions of the contact, the material chosen and the method of applying the conductive material can also be varied according to the design parameters and cost considerations. Accordingly, the foregoing description should be considered as merely illustrative of the principles of the present invention and not in limitation thereof, since the scope of the present invention is defined by the following claims.

Having thus described the invention, what is claimed is:

1. A method of making an electrical connector comprising the steps of:
forming a plurality of electrical contacts on a single sheet of conductive material;
placing at least one insulating body around at least a portion of the single sheet of conductive material; and
singulating at least one of the plurality of electrical contacts from the contact sheet.

2. A method including the steps of claim 1 wherein the step of placing an insulating body around the sheet of electrical contacts includes the step of molding the body in the desired shape and positioned in the desired location with respect to the electrical contacts, whereby the molded body encapsulates a middle portion of at least one electrical contact having a distal end and a proximal end conjoined in the middle portion, the distal end and the proximal ends emanating from opposing surfaces of the contact sheet respectively.

3. A method of making an electrical connector including the steps of claim 1 wherein the step of forming a plurality of electrical contacts includes the step of forming at least one electrical contact having a distal end extending from one side of the sheet and a proximal end extending from the other side of the sheet, wherein the distal end and the proximal end remain conjoined in a middle section of the contact as a unitary body.

4. A method of making an electrical connector including the steps of claim 1 wherein the distal end of at least one electrical contact emanates from and projects a distance x above a first surface of the contact sheet, and the proximal end emanates from and projects a distance y above a second, opposing surface of the contact sheet, whereby x is greater than y.

5. A method of making an electrical connector including the steps of claim 1 wherein the process of forming a plurality of electrical contacts includes the step of forming spring projections which are cantilevered from an attachment point.

6. A method of making an electrical connector including the steps of claim 1 wherein the process of forming a plurality of electrical contacts on a sheet includes the step of plating a portion of the contact with a material to improve the electrical contact resistance of the electrical contact.

7. A method of making an electrical connector including the steps of claim 1 wherein the step of singulating the electrical contacts from the sheet includes the step of using a mechanical stamping process to separate an electrical contact from the sheet.

8. A method of making an electrical connector including the steps of claim 1 wherein the step of forming the plurality of electrical contacts on a sheet includes the step of forming locating indicia on the sheet and the step of placing an insulating body around the single sheet of conductive material includes the step of using the locating indicia to position the insulating body in the desired location with respect to the sheet.

9. A method of making an electrical connector including the steps of claim 1 wherein the step of forming the electrical contacts includes the step of forming at least a first portion of an electrical contact extending on one side of the sheet and at least a second portion of the electrical contact extending on the other side of the sheet, the first section and the second section comprising a unitary body.

10. An electrical connector comprising:
a sheet of conductive material including a plurality of electrical contacts formed as a part of a single sheet, such that a distal end of at least one electrical contact emanates from and projects above a first surface of the contact sheet, and a proximal end of the at least one electrical contact emanates from and projects above a second, opposing surface of the contact sheet, the distal end and the proximal end of the electrical contact comprising a unitary body conjoined in a middle section of the contact;
at least one housing of non-conductive material which is positioned around at least a portion of the sheet including the middle section of at least one of the plurality of electrical contacts; and
whereby at least one of the plurality of electrical contacts is electrically isolated from the contact sheet.

11. An electrical connector of the type described in claim 10 wherein the sheet of conductive material includes locating indicia to position the housing in the desired location with respect to the electrical contacts.

12. An electrical connector of the type described in claim 10 wherein the locating indicia include a plurality of spaced apertures and the housing includes projections to fit within the spaced apertures and located the housing in the desired position with respect to the electrical contacts.

13. An electrical connector of the type described in claim 10 wherein the sheet of conductive material includes a first electrical contact projection from one side of the sheet and a second electrical contact projecting from the opposite side of the sheet.
